(19) United States
(12) Patent Application Publication
(10) Pub. No.: US 2015/0170164 A1
(43) Pub. Date: Jun. 18, 2015

(54) METHODS AND SYSTEMS FOR USING SCANABLE CODES TO OBTAIN A SERVICE

(71) Applicant: Flashback Survey, Inc., Chapel Hill, NC (US)

(72) Inventor: Peter Joseph Marsico, Chapel Hill, NC (US)

(21) Appl. No.: 14/570,804

(22) Filed: Dec. 15, 2014

Related U.S. Application Data
(60) Provisional application No. 61/963,854, filed on Dec. 14, 2013.
(60) Provisional application No. 62/001,673, filed on May 22, 2014.
(60) Provisional application No. 62/019,838, filed on Jul. 1, 2014.

(51) Int. Cl. G06Q 30/02

(52) U.S. Cl. CPC G06Q 30/0201

(57) ABSTRACT

A mobile communication device may include a scan client module for scanning and communicating QR code information. QR code scanning is accomplished by a camera module that is associated with the smartphone or other mobile computing device. The scan-enabled client module communicates the scanned QR code information to an associated server application for collecting, processing and reporting scan data. Service code information is extracted from the scan code and used to facilitate the storage of and subsequent access to user specified event planning information that includes event initiation and termination information. If the scan code/tag is affixed to an item that is subsequently lost, when the owner's code is scanned by another user, the finding user is instructed where to take the lost item so that it may be safely recovered by the owner. According to another aspect, service code information is extracted from the scan code and used to facilitate the creation of a parking reminder record that is bound to the scanning user and which identifies the associated parking space.

### PRIORITY CLAIM

This application claims the benefit of U.S. Provisional Patent Application Ser. No. 61/963,854, filed Dec. 14, 2013, U.S. Provisional Patent Application Ser. No. 62/001,673, filed May 22, 2014, and U.S. Provisional Patent Application Ser. No. 62/019,838, filed Jul. 1, 2014; the disclosures of which are incorporated herein by reference in their entireties.

### TECHNICAL FIELD

The subject matter described herein relates to methods and systems for using a scanable service code to initiate and facilitate a scan-triggered user service.

### BACKGROUND

Applications often require users, such as the users of mobile communication devices, to manually activate and interact with software in order to utilize the associated services. For example, information collection systems that are typically deployed to gather information from a consumer of goods and services are often intrusive and time consuming from the perspective of the consumer. While such information collection systems are capable of gathering detailed information from and providing useful services to a consumer, these systems require a relatively high level of user interaction to obtain the associated services, and furthermore do not give the user an incentive to participate nor an easy way to obtain high-utility services.

In light of these problems, what is needed is a system and method for providing high-utility scan-triggered services to a user.

### SUMMARY

According to one aspect, the subject matter described herein includes systems and methods for providing scan-triggered application services, such as for example user feedback surveying, using a scan code, such as a bar code, a quick response (QR) code, an RFID tag/code, a NFC tag/code, or other scanable code element. In one embodiment, a mobile communication device such as a smartphone, tablet computer or other mobile computer is adapted to include a scan-triggered service client module for scanning and communicating QR code information. QR code scanning is accomplished by a camera module that is associated with the smartphone or other mobile computing device. The scan-triggered service client module communicates the scanned QR code service information to an associated server application for collecting, processing and reporting survey data. In one embodiment, the application service code information contained in the scanned QR code is decoded by the scan-triggered service client module and communicated to the associated server application. The application service code information encoded in the QR code may include information that is sufficient to identify a client entity (e.g., a local retailer or merchant) and a survey response option. The server application is adapted to receive the scanned information sent by the scan-triggered service client module and to store, analyze and generate reports based on the information.

According to one aspect of the subject matter disclosed herein, a scan-triggered service code that includes a service identifier is bound to a user. When scanned by the user, service code information is extracted from the scan code and used to facilitate the storage of and subsequent access to user specified event planning information that includes event initiation and termination information. Guardian notification triggers may be set, which are fired is the user does not close-out an active event within a prescribed close-out period. When fired, guardian notification triggers cause notification messages to be sent to provisioned guardians for the associated event.

According to another aspect of the subject matter disclosed herein, a scan-triggered service code that includes a service identifier is bound to a user, who is designated as the owner of the scan code. If the scan code/tag is affixed to an item that is subsequently lost, when the owner's code is scanned by another user, the finding user is instructed where to take the lost item so that it may be safely recovered by the owner.

According to another aspect of the subject matter disclosed herein, a scan-triggered service code that includes a service identifier is bound to a parking space. When scanned by the user, service code information is extracted from the scan code and used to facilitate the creation of a parking reminder record that is bound to the scanning user and which identifies the associated parking space. When the user subsequently scans a parking reminder retrieval scan code, the user is presented with a reminder that identifies the user's parking space.

The subject matter described herein for facilitating scan-triggered services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a non-transitory computer readable medium having stored thereon computer executable instructions that when executed by the processor of a computer perform steps. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a functional block diagram which illustrates a mobile communication device that includes a scanable code reader module, such as a quick response (QR) code scanner module and exemplary scan-enabled client module;

FIG. 2 is a functional block diagram which illustrates a scan-triggered application server that includes an exemplary server application module;

FIGS. 3A-3C illustrate exemplary Sherpa Square Flight Plan Service provisioning and user registration processing scenarios;

FIG. 4 illustrates exemplary Sherpa Square Flight Plan Service event creation processing;

FIG. 5 illustrates exemplary Sherpa Square Flight Plan Service event start confirmation processing;

FIGS. 6A and 6B illustrate exemplary Sherpa Square Flight Plan Service event timeline and associated processing in the case where the event is not closed out prior to firing of the notification trigger;

FIGS. 7A-7C illustrate exemplary Sherpa Square Flight Plan Service event timeline and associated processing in the case where the event is closed out prior to firing of the notification trigger;

FIGS. 8A and 8B illustrate exemplary Sherpa Square lost and found anonymous recovery service processing;

FIG. 9 illustrates exemplary Sherpa Square digital reward distribution processing;

FIGS. 10A-10C generally illustrate exemplary data and data structures associated with exemplary embodiments of Sherpa Square Service;

FIG. 11 illustrates exemplary Parking Square Parking Reminder Service provisioning and processing;

FIGS. 12A and 12B illustrate exemplary parking reminder setting and retrieval processing according to an exemplary “dual purpose” scan code embodiment of Parking Square Parking Reminder Service;

FIGS. 13A and 13B illustrate exemplary parking reminder setting and retrieval processing according to an exemplary “single purpose” scan code embodiment of Parking Square Parking Reminder Service; and

FIGS. 14A and 14B generally illustrate exemplary data structures associated with exemplary embodiments of Parking Square Parking Reminder Service.

### DETAILED DESCRIPTION

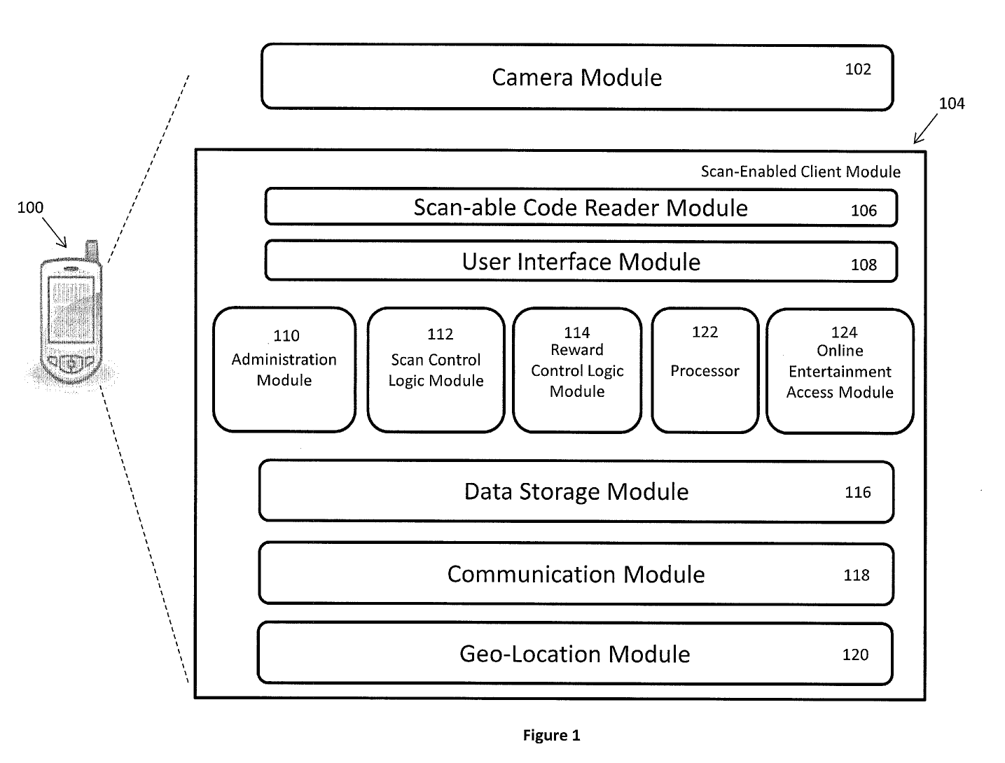

Disclosed are systems and methods for using a scanable code, such as quick response (QR) code, a near field communication (NFC) code, radio frequency identification (RFID) code, or similar optical, magnetic or electrical scanable codes, to provide a service to a user who scans the code. In a one embodiment, a scan code-based services system of the subject matter described herein includes a scan-enabled client module, which may be implemented in hardware, software, filmware or a combination thereof and which resides on a mobile communication device, such as a smartphone, tablet computer, netbook computer, computer-integrated eyeglasses, computer-integrated wristwatch, wearable electronics or other mobile computing device that is capable of communicating with a network server. The scan-enabled client module may include an executable computer program (e.g., C++, Java, etc.) that is adapted to be downloaded onto the mobile communication device, installed and executed. The scan-enabled client module may also include a web browser that is adapted to access and execute web-based software (e.g., JavaScript, etc.) that provides a least a portion of the necessary scan-enabled client functionality. FIG. 1 is a block diagram that illustrates an exemplary architecture of a smartphone-based scan-enabled client module. Mobile device 100, which may be a smart phone or other mobile computing device, includes a camera 102 that is adapted to capture and store an image in a digital format. Smartphone 100 also includes a scan-enabled client module 104. Scan-enabled client module 104 is comprised of scanable code reader module 106, a user interface module 108, an administration module 110, a scan control logic module 112, a reward control logic module 114, a data storage module 116, a communication module 118, and geo-location module 120, a processor 122, and an online entertainment access module 124.

The extracted scan-triggered service information may comprise information that is representative, for example, of an alphanumeric text string or a numeric code. In one embodiment, the extracted scan-triggered service information may be used to identify and facilitate the providing of scan-triggered rewards based on the scanning of service scan codes. The decoded scan code information is provided to an associated server application module via communication module 118. In an alternate embodiment, scan code reader module 106 is adapted to receive digital image information from camera 102 and to communicate the digital image information (e.g., JPEG) to an associated server application module via communication module 118 where decoding processing is performed. In one embodiment, information that identifies or can be used to identify a scan-triggered service user (e.g., user name, user ID, session ID, etc.) is also provided to the server application module.

User interface module 108 is adapted to present the mobile device user with a graphical user interface for enabling the user to generally control and operate the functionality of the scan-enabled client module 104. User interface module 108 is adapted to present a menu structure to the user and enable the user to navigate this menu structure. The menu structure provides a user with access to administrative functions, such as scan triggered service account settings (e.g., username, password, service preferences, personal information, etc.), account log-in. Such administrative functions are controlled within scan-capable or scan-enabled client module 104 via administration module 110. The menu structure may also provide the user with the ability to control the associated smartphone camera. In some embodiments, the ability to access and operate the smartphone camera in the manner required to effectively photograph or scan a scan code icon, such as a QR code, is provided via scan control logic module 112. In one exemplary embodiment, scan-enabled client module 104 may include a native application that is adapted to execute on mobile device 100, and in such a case that native application may include QR scanning/decoding capability or alternatively scan-enabled client module 104 may simply invoke the services of a third-party QR scanner/decoder that is installed in the mobile device. In another exemplary embodiment, a third-party QR scanner/decoder may be invoked by the mobile device user to scan and decode a suitably provisioned QR, where decoding of the QR code causes a web browser instance to be launched and directed to a URL associated with the application server. In this case, information that identifies the relevant/necessary scan-triggered service information may be passed to the application server via the URL/URL parameters. For example, in one embodiment, information that identifies a scan-triggered service and relevant/necessary service information may be explicitly or implicitly communicated to the application server via the URL itself (e.g., the host name and/or path and/or query string components of the URL can be used by the application server to explicitly or implicitly identify the service information). In an alternate embodiment, for example, all communications between the user's mobile device and the application server may be addressed to a URL which points to a scan-based service provider (e.g., www.flashbacksurvey.com), and the information that identifies the scan-triggered service may be communicated to the scan-based service provider's application server via the path and/or query string parameter portions of the URL. In one embodiment, such a URL address associated with the scan-triggered service platform may be encoded or otherwise incorporated into a scan code associated with a scan-triggered service platform, or which requests scan-triggered application service from a scan-triggered service platform. In one embodiment, the URL which points scan-based service provider (e.g., www.flashbacksurvey.com), and the information that identifies the scan-triggered service may be encrypted, such that only a particular code scanner, native mobile code scanning application, or mobile web browser with integrated code scanning capability which has access to or is provisioned with the appropriate decryption/de-obfuscation key information can decode and process the scan-triggered service URL information and thereby facilitate the providing of the associated scan-triggered service. As such, a particular scan-triggered service code may be “locked” to all code scanners but the scanner that has access to/is provided with the appropriate decrypt/de-obfuscation key information, thereby providing users with an added measure of security with respect to accessing scan-triggered services.

The menu structure also provides the user with the ability to access and redeem participation rewards. Participation reward access and redemption functionality is provided by reward control logic module 114. Data storage module 116 is adapted to provide both long term storage of data associated with the scan-enabled client module, as well as short term, cache-type storage of scan client related data. Exemplary uses of the data storage are discussed in more detail in the disclosure that follows.

Communications module 118 is adapted to facilitate the communication of information between scan-enabled client module 104 and an associated server application module. For example, communication module 118 may receive information from scan control logic module 112 that is to be communicated to an associated server application module. Communication module 118 may package the information according to a pre-defined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), WiMax, Wi-Fi, long term evolution (LTE), etc. For example, in one embodiment, when a user scans a service scan code associated with a scan-triggered service, communication module 118 is adapted to communicate to an associated server application module information that was encoded in the scanned service code as well as information that can be used to identify the user. Information that can be used to identify the user may include a user identifier (e.g., username, email address, mobile IP address, session ID, etc.). It will be appreciated that the communication of such user identifying information to the server module may be triggered upon scanning of the QR code or may be triggered upon startup of software associated with scan-enabled client module 104 (e.g., auto-login, manual login, etc.). As such, the communication of user identifying information and information obtained from the scanning of a scan code may be accomplished via a single message that is communicated between scan-enabled client module 104 and an associated server module, or this information may be communicated via multiple messages to the application server module. In one embodiment, when a user presents login credentials (e.g., username and password) and is successfully authenticated, a communication channel or session is established between a scan-enabled client module (e.g., a smartphone web browser or native application) and a server application module (e.g., an application residing on a network-based host computer), and all subsequent communications made via the session or channel are associated with the user's login credential/identity information. In this way, a user's identity information may be provided before, during, or even after the scanning of an associated service scanable code (e.g., QR code, NFC code, RFID code, etc.), and thereafter bound to the information derived or obtained from scanning of the code. In another embodiment, the scanning of a scan code by a user triggers the scan-enabled client module 104 to access previously stored login credential information (e.g., login credential information stored in a file or cookie that is resident on mobile communication device 100. Scan-enabled client module 104 automatically provides the user's login credentials to the application server module, which then associates the information obtained from the scanning of the scan code with the user's account. Once the session is established, information obtained and provided to the application server module is automatically associated with the user's account. These same user identity binding techniques may be employed with any of the embodiments of the subject matter described herein.

Geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling the server application module to identify and store the location at which a QR code was scanned. Alternatively, geo-location or position information may be encoded in the QR code that was scanned, and once scanned the location information may be decoded by geo-location module 120 and passed along to a server application module associated with the scan code-based service system. It is understood that with the addition of scan-enabled client module 104, mobile device 100 becomes a special purpose computing platform that improves the functionality of mobile device 100 by providing direct access to a server application in response to receiving a scanned code from camera 102. Mobile device 100 with scan-enabled client module 104 also improves the technological field of network access to services because such services can be accessed automatically and quickly with a reduced likelihood of data entry errors. In some embodiments of the subject matter described herein, scan-enabled client module 104 may also improve the technological fields of food science and individual health management by providing automatic access to food information, including individualized food allergen information, in response to the scanning of a scanable code. Processor 122 is adapted to facilitate the execution of software and firmware associated with the operation of modules 106, 108, 110, 112, 114, 116, 118, 120, 122 and 124 which are used to provide the overall scan-enabled client module functionality described herein. Exemplary implementations of processor 122 include, but are not limited to, one or more single-core microprocessors, one or more multi-core microprocessors, and one or more programmable logic devices (e.g., complex programmable logic devices, a field-programmable gate arrays, etc.). Online entertainment access module 124 may comprise hardware, software or firmware that is adapted to facilitate the accessing (e.g., playing, viewing, listening) of online entertainment services, such as online game, online video, and online music services.

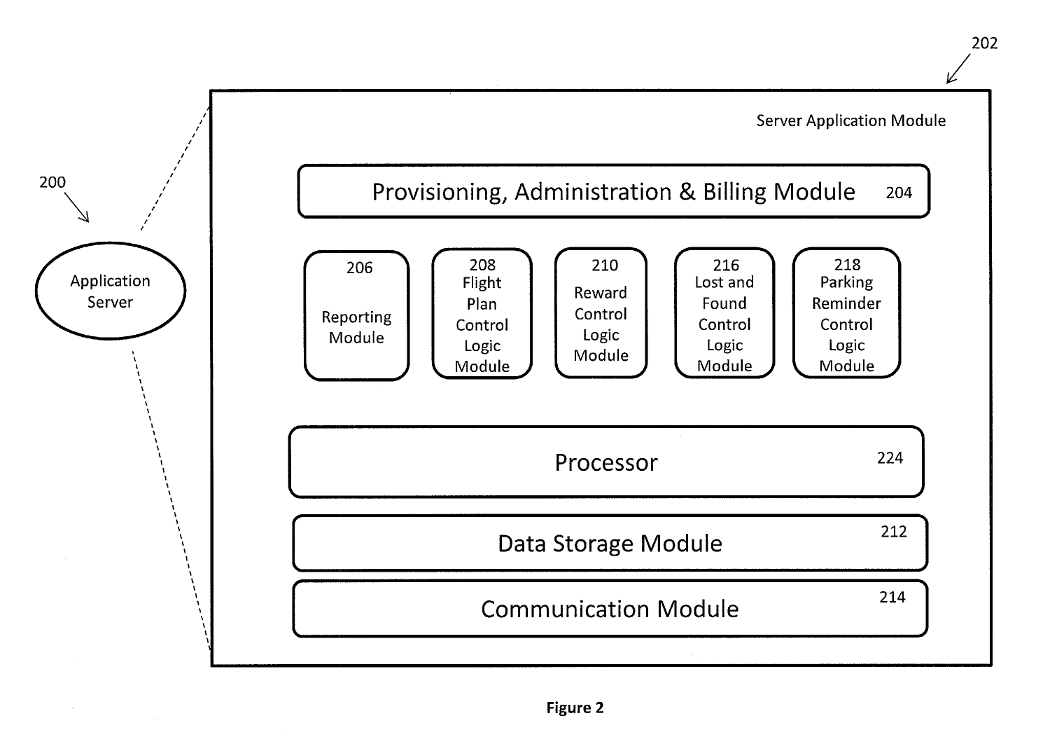

Shown in FIG. 2 is a block diagram that illustrates an exemplary architecture of a server application module 202, which resides and executes on a network or cloud-hosted application server 200. In the embodiment presented in FIG. 2, the server application module is comprised of a provisioning, administration and billing module 204, a reporting module 206, a Flight Plan Square control logic module 208, a reward control logic module 210, a data storage module 212, a communication module 214, a Lost And Found Square control logic module 216, a Parking Reminder Square control logic module 218, and processor 224. The purpose and function of each of these modules and of the processor is described below. Server application module 202 executing on application server 200 makes application server 200 a special purpose computing platform that improves the functionality of application server 200 by configuring application server 200 to process received scanned codes and providing the indicated service in response to receiving the scanned codes. As such, server application module 202 improves the technological fields of network access to services by providing such services automatically in response to receiving the scanned codes and with a reduced likelihood of data entry error. In some embodiments of the subject matter described herein, server application module 202 may also improve the technological fields of food science and individual health management by providing automatic access to food information, including individualized food allergen information, in response to the scanning of a scanable code. The purpose and function of each of these modules is described below.

Provisioning, administration and billing module 204 is adapted to provide access for a provisioning entity or user, such as a medical office administrator, merchant entity, a delivery service vendor entity, an event venue entity, mobile user entity or a system administrator, to provision registration information, subscription configurations/preference information, service configuration information, and participation reward content information. In the context of this disclosure, a user is considered to be the operator or user of a mobile communication device (e.g., computer integrated eyewear, wearable computer, smartphone, tablet computer, etc.) that includes a scan-enabled client module, and is therefore capable of scanning a QR code (or other encoded, scanable code) and provide, trigger, initiate or facilitate the providing of a service to the user. For example, a user may be a consumer of goods and services provided by a merchant, an attendee of an event, a recreational equipment user, a shopper, or an employee of a corporation.

In all of the embodiments disclosed herein, a scanning user may be granted or credited with a digital reward or coupon in response to the scanning of an associated scan-triggered service code. Exemplary digital rewards may include, but are not limited to, a digital or electronic coupon associated with a good or a service, a credit for an online gaming service, a credit for an online video, an audio or video download. In one embodiment, the value of a granted digital reward may be determined, based at least in part, on the type/brand/manufacturer of the mobile phone that was used to scan the associated scan-triggered service scan code. In one embodiment, such rewards may be credited or placed in a digital reward wallet associated with the user, whereby the user can access and redeem a granted reward. In one embodiment, a reward granted to a user may be granted at a first value (e.g., $1 off next purchase) and subsequently modified to a second value (e.g., $2 off next purchase) at a later by Reward Control Module 210.

Module 210 may facilitate the sharing of a scan-triggered service platform-granted reward from one user to another user, where sharing may include the gifting, transferring, or cloning of a granted reward. In this case, a first user who is the current owner of a reward selects the reward and identifies a second user to whom the reward is to be transferred. The first user then communicates information that identifies both the reward and the “transferred to” user to module 210. The information that identifies the “transferred to” or recipient user may be a username or user ID provided by the recipient user at the time of registration by the recipient user. Module 210 receives, processes and logs the transfer request and updates the appropriate reward data so as to execute the transfer. In one embodiment, reporting module 206 enables an administrative entity or user to view, track and analyze such reward transfers. In various embodiments of the subject matter described herein, restrictions/limitations/qualifications may be imposed on rewards that are to be transferred or gifted from one user to another. For instance, module 210 may include reward transfer or gifting rules that specify those conditions under which a reward may be transferred and/or those conditions under which a reward may not be transferred. These rules may be stored in a database, table, or data structure that is contained within or accessible by module 210. An exemplary rule may state that a reward may only be transferred or gifted to a new user (e.g., a user that has registered for service within the past 30 days, etc.). In order to enforce this rule module 210 may access user registration data that is maintained in data storage module 212. Another exemplary rule may state that a reward may only be transferred or gifted to a user who has not previously patronized the scan-triggered service client entity with which the reward is associated. In order to enforce this rule module 210 may access user transaction data that is maintained in data storage module 212.

In one embodiment, reward sharing functionality includes functionality where an existing user may clone/copy, transfer or gift a reward to an individual who has not yet become a registered scan-triggered service user. To facilitate such a special transfer, the existing user communicates information that identifies both the reward and the “transferred to” or recipient user to module 210. In this case, since the recipient user is not yet a registered user of the system/service, the existing user must specify a public contact address for the intended recipient. Exemplary public contact addresses may include, but are not limited to, an email address, a mobile telephone number, a mobile subscriber ISDN (MSISDN), a Twitter address, an instant message address. Module 210 receives processes and logs the transfer request. In one embodiment, module 210 is adapted to generate a message that is addressed to the specified public contact address (e.g., email address). In one embodiment, the message may include the transferred reward or information specifying how the transferred reward may be obtained and redeemed. In another embodiment, the message may include information that describes the pending reward transfer and also provides a hyperlink/URL associated with a web page where the intended recipient may register and thereby receive and redeem the transferred reward. The existing user that transferred or gifted the reward (thereby resulting in the recruitment/registration of a new subscriber) may be issued a new reward as a result of the transfer. The new reward may be the same as the transferred reward or different. The new reward may be issued by reward control logic module 210.

Processor 224 is adapted to facilitate the execution of software and firmware associated with the operation of modules 204, 206, 208, 210, 212, 214, 216, 218, 220 and 222, which is used to provide the overall server application module functionality described herein. Exemplary implementations of processor 224 include, but are not limited to, one or more single-core microprocessors, one or more multi-core microprocessors, and one or more programmable logic devices (e.g., complex programmable logic devices, a field-programmable gate arrays, etc.).

Flight Plan Service

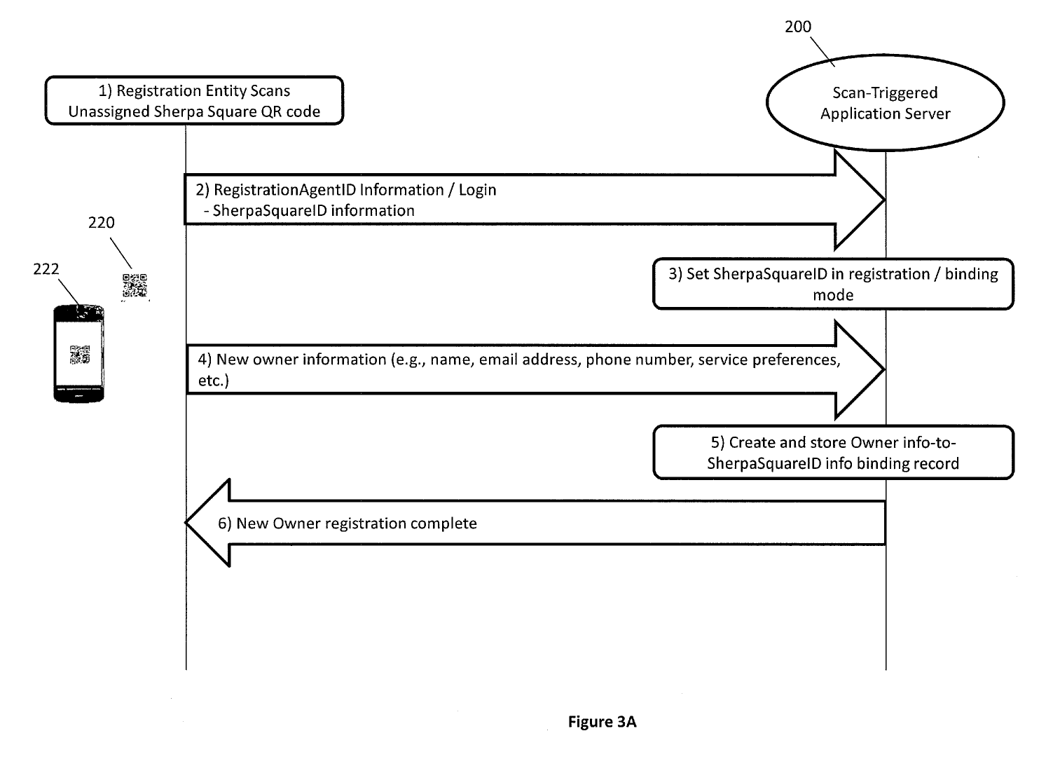

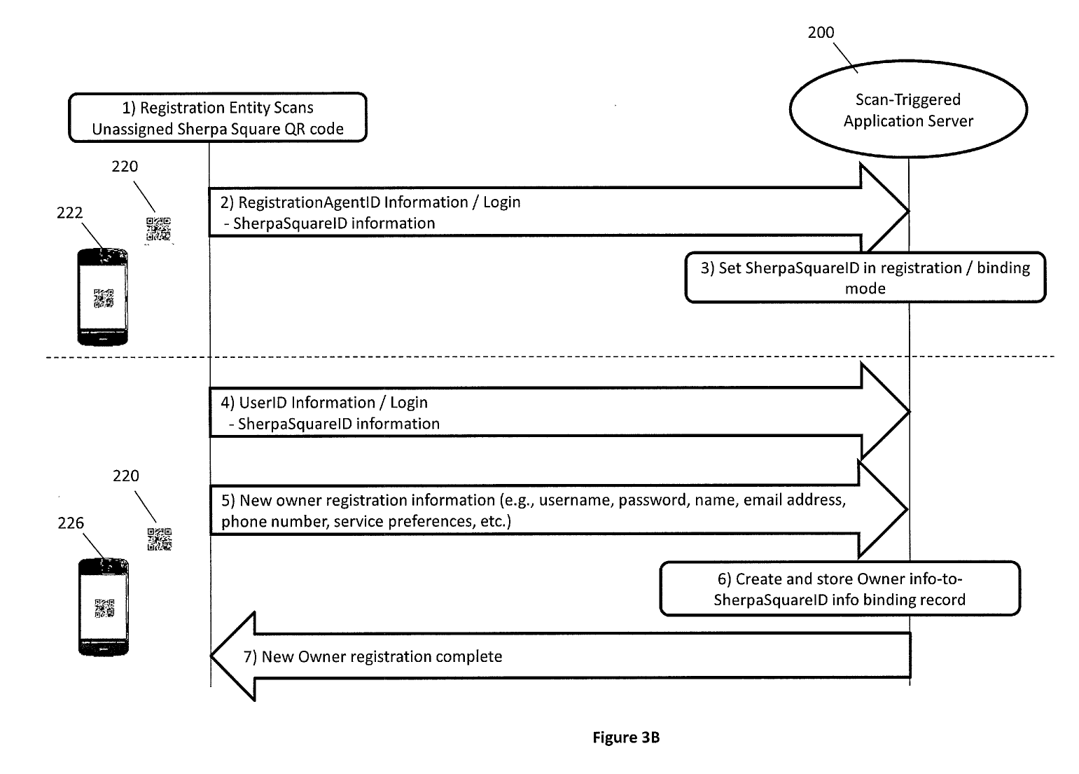

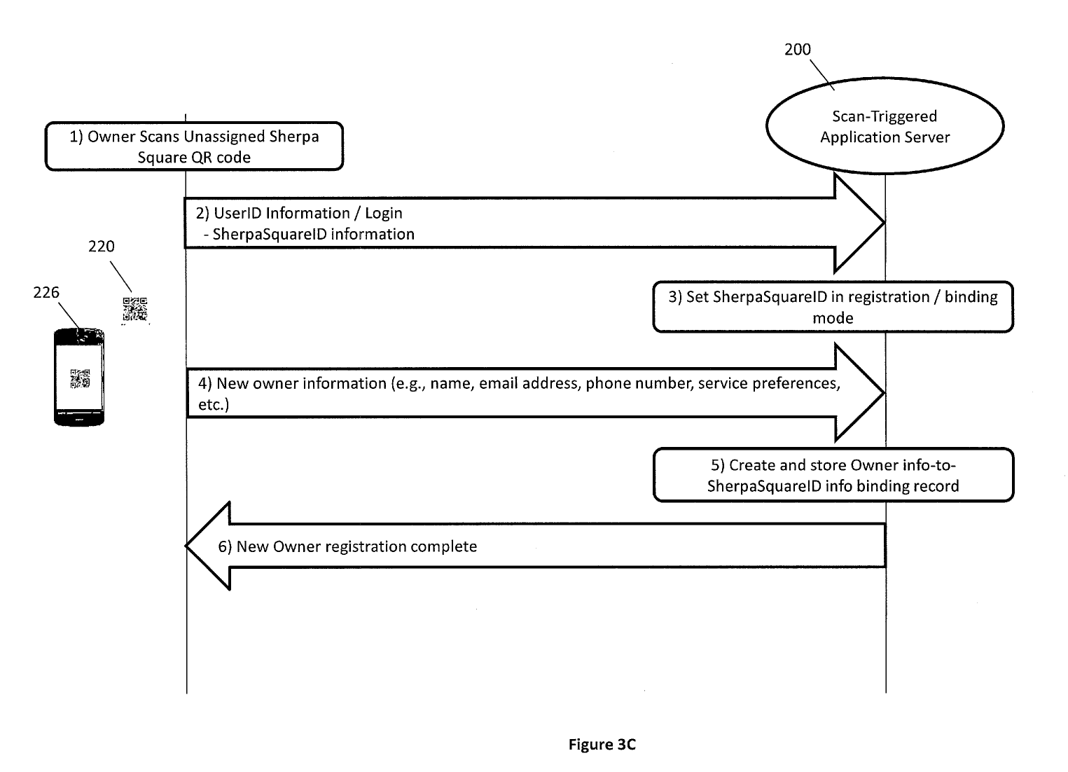

Shown in FIG. 3A is diagram that generally illustrates the provisioning of information associated with one embodiment of a service of a scan code-based service system of subject matter described herein. This service is referred to herein as Flight Plan Service, which is a scan-based service that enables a service user (e.g., a hiker, biker, sailor, student, etc.) to create and store a “flight plan” for an event. The flight plan may include departure time, expected route, and arrival time at the destination. Exemplary events, may include a wilderness hike, a biking excursion, a sailing excursion, a jog/run, a trip, or any other type of excursion (large or small, urban or wilderness) that may be undertaken by an individual. Flight Plan Service may be activated/accessed by mobile phone or mobile computer (e.g., tablet) users via the use a scanner (e.g., QR code scanner, NFC scanner, RFID scanner, Bluetooth scanner, etc.) associated with the mobile device. More particularly, a scanable QR code, referred to herein as a Sherpa Square, associated with Flight Plan Service is created and includes encoded information that can be used, at various times during the use cycle, to uniquely identify both a physical item (e.g., a backpack, hat, coat, gloves, mobile phone, tablet computer, or any physical item on which the QR code can be placed) and the owner to whom the item is registered.

One exemplary use of Flight Plan Service involves a merchant/retailer who would like to offer such service to consumers that purchase a backpack or other outdoor goods from the merchant's store. For example, a retail merchant may generate a Sherpa Square QR code tag for each backpack in the merchant's store and affix these Sherpa Square QR code tags to each backpack. Exemplary Sherpa Square QR code tags may be metal “dog tag”-like tags, or may be “soft” tags (e.g., fabric, thin polymer, etc.) that can be affixed to each backpack by sewing/stitching, or via embroidering. Once a backpack is purchased, the associated Sherpa Square QR code tag is registered to the new owner via a registration process. Once the Sherpa Square QR code tag is registered, the owner can scan the Sherpa Square QR code tag with the QR code scanner on the owner's mobile phone (or other mobile communication/computing device). Upon scanning the owner's Sherpa Square QR code, the owner is presented with a Flight Plan Service dashboard, which enables them to create a flight plan for an Event. The owner is prompted to input information associated with the Event which may include, but is not limited to, an Event name or identifier, the starting location of the Event (e.g., nearby town name, trail/trailhead name, campground name, destination landmark/building name, etc.), the starting date and time of the Event, the ending location of the Event (e.g., nearby town name, trail/trailhead name, campground name, destination landmark/building name, etc.), the ending date and time of the Event, an alert delay time period (e.g., 2 hours, 1 day, etc.), one or more contact addresses (e.g., email addresses, text message addresses, Twitter handles, instant messaging service addresses, etc.) of individuals who are to be notified in the event that the owner does not “close-out” the Event (e.g., the Owner goes on a hike for the weekend and does not return and “close-out” the hike Event as scheduled).

Flight Plan Service may also provide the owner with a reward, such as a digital coupon, in exchange for scanning/using the owner's Sherpa Square scan-code (e.g., QR code). Such digital rewards may be credited to a digital reward wallet associated with the user's scan triggered service account. The scan-based services platform that facilitates the Flight Plan Service may track redemption of such digital rewards by the Owner. It will be appreciated that in another deployment scenario, a Sherpa Square may be affixed to the steering console of a recreational boat, such as a fishing or ski boat, or on other watercraft, such as a kayak or jet-ski, such than an operator could quickly scan the Sherpa Square QR scan code prior to an outing and file a safety flight plan, as described below.

Illustrated in FIG. 3A is one exemplary way in which a Sherpa Square QR code tag 220 may be registered to an Owner. In this example, Flight Plan control logic module 208 of scan-triggered application server 200 is adapted to host the software application that provides/facilitates scan-triggered Flight Plan Service, where application server 200 is a network server that can be reached or accessed via a network connection, such as an Internet connection. It will be appreciated, as generally indicated in step 1, that a Sherpa Square QR code tag may be generated with the assistance of QR code creation/generation services provided by the software system that facilitates Flight Plan Service operations, such as application server 200. Alternatively, Sherpa Square QR code tags may be generated by a software system and production means that is separate from application server 200. In any event, in this example, to register a Sherpa Square QR code 220 to a new owner, a registration agent (e.g., a sales associate, administrator, organization staff member, etc.), who has previously been provisioned in the scan-triggered system, scans the un-registered Sherpa Square QR code 220 with the QR code scanner on mobile phone 222. When the registration agent scans the Sherpa Square QR code 220, registration agent identifying information (e.g., login or security credential information, etc.) is communicated to application server 200 (step 2). Such login/registration agent identifying information may, for example, be stored on the registration agent's mobile phone 222 in the form of a cookie, or other similar local data storage mechanism. Alternatively, the registration agent may be prompted to manually input such login/registration agent identifying information upon scanning of the Sherpa Square QR code. In any event, once the registration agent's identity credentials have been provided to application server 200, the registration agent is authenticated. Assuming the registration agent is authenticated and validated, application server 200 recognizes the scanning registration agent as an authorized registration agent, and registration processing proceeds. Exemplary registration agent provisioning information is illustrated in Table 2, which includes MerchantEntityID identifier information 310, RegistrationAgentID identifier information 312, ReceivingAgentID identifier information 314 and StoreID identifier information 316. Also communicated to application server 200 as a result of the Sherpa Square scan is one or more identifiers referred to in this example as SherpaSquareID information. This identifier or group of identifiers is used to uniquely identify the Sherpa Square tag, and hence the associated backpack or other physical item with which it has been affixed/associated and item's registered owner. Additional information may be associated with the SherpaSquareID and such auxiliary information may be bound to the SherpaSquareID identifier and stored in a binding record structure at the scan-triggered Sherpa Square service hosting server 200. The identifier or group of identifiers may also be used, for example, to identify the retail merchant where the Sherpa Square tag and associated backpack were sold or an organization or organizational entity with which the owner is associated, such as a youth sporting team, a non-profit organization, a children's museum, retail business, a photo hosting/sharing site, etc. SherpaSquareID values are encoded within the scan code, such as a QR scan code. In this example, receipt of registration agent identifying information and associated SherpaSquareID information is interpreted by server 200 as a request to register a user as an owner of the associated Sherpa Square tag/SherpaSquareID (step3).

In step 4, the provisioning entity is prompted to enter/communicate identity information associated with the new owner/registrant to application server 200. Exemplary new owner/registrant identity information may include, but is not limited to, user/owner name, email address, email Twitter handle, text message service address, street address, phone number, zip code, gender, Sherpa Service setting preferences, outdoor activity preferences, etc.

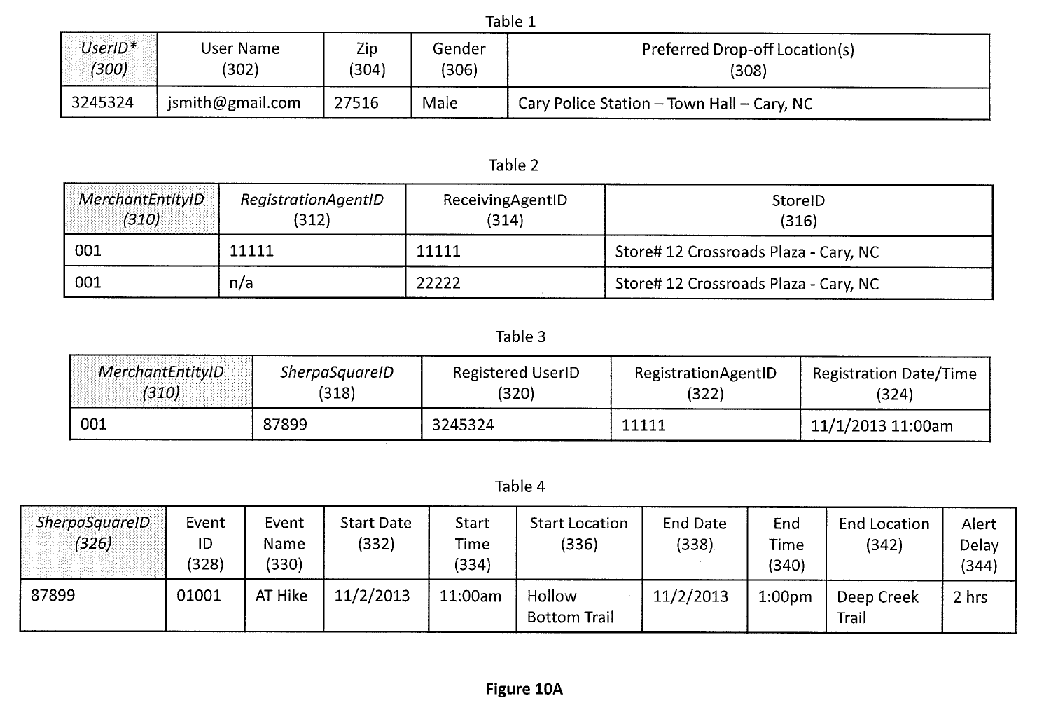

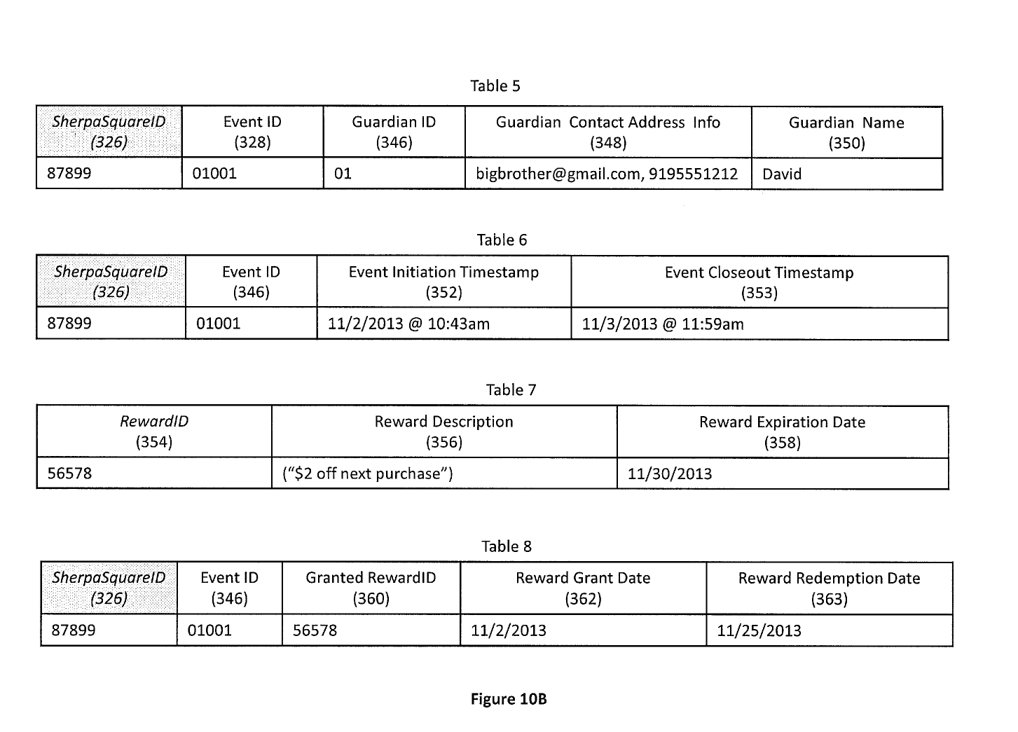

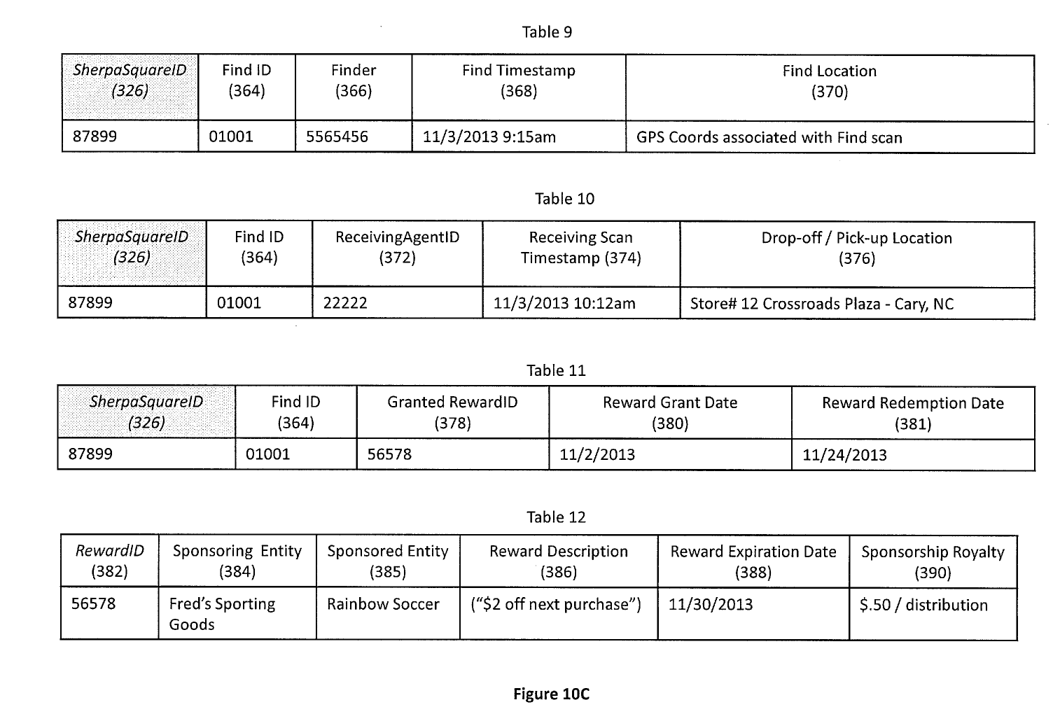

In step 4, registration agent 222 provides new owner information, such that the associated SherpaSquareID is bound to the new owner/user. Exemplary user/owner information is presented in Table 1 (FIG. 10A) and includes UserID information 300 that may be used to identify a scan-triggered service user, user name credential information 302 (e.g., scan-triggered service account username, email address, full name, etc.), address information 304, gender information 306, and preferred drop-off/pick-up location information 308 (e.g., information that identifies a preferred location for picking up a lost item that is recovered and returned). In step 5, once owner registration processing is complete, the identifier or group of identifiers is used by application server 200 to identify the current owner/registrant (i.e., application server 200 may create and store a binding record that associates the identifier or group of identifiers with the current owner/registrant). Exemplary Sherpa Square service owner registration binding record information is illustrated in Table 3. This exemplary owner registration binding record information includes a MerchantEntityID identifier 310, a SherpaSquareID information 318, Registered Owner UserID 320, RegistrationAgentID 322, and Registration Timestamp information 324. In step 6, registration confirmation information/communication may be sent by application server 200.

In an alternate embodiment shown in FIG. 3B, to register a Sherpa Square QR code 220 to a user/new owner, a registration agent 222 (e.g., a merchant) scans the Sherpa Square QR code with the QR code scanner on the registration agent's mobile device. Registration agent login information is collected and communicated to application server 200 in a manner similar to that described above in the previous embodiment (steps 1 and 2) and server 200 interprets receipt of the registration agent scan as a request to register the associated SherpaSquareID to a user (step3).

In step 4, the new owner/registrant 226 is then directed to scan the same Sherpa Square QR code 220, which is now “primed” for registration. In step 5, the new owner/registrant 226 is prompted to enter/communicate his or her identity and associated registration information in a manner similar to that described above in the previous embodiment. In step 6, server 200 binds the user's registration information to the associated SherpaSquareID identifier value and stores this binding information. Registration confirmation information/communication may be sent by application server 200 (step 7).

It will be appreciated that in other embodiments, owner registration may be performed or initiated by a registration agent using either mobile or “desktop” administration terminals in a manner that is functionally similar to the two exemplary embodiments presented in FIGS. 3A and 3B.

Shown in FIG. 3C, is yet another embodiment in which a user may register himself as the owner of a Sherpa Square code/tag without interaction with or by a registration agent. This mode of operation may be used to provide a mode of operation that gives user's a “one-time” self-registration process. For example, a Sherpa Square tag may be created and maintained in a “virgin” un-registered state until it is distributed to a user (e.g., a user purchases a backpack that includes a virgin Sherpa Square tag). In the simple example shown in FIG. 3C, user 226 scans virgin Sherpa Square scan code/tag 220, step 1. In step 2, user identifying information and SherpaSquareID information extracted from the scan code/tag is communicated to server 200. In the case where the scanning user 226 is not a subscriber of scan-triggered services provided by scan-triggered server 200, then the user may be prompted to enter scan-triggered service subscription information (i.e., become a registered user of the scan-triggered service provider, etc.). In step 3, server 200 interprets the scan as a request to register the associated Sherpa Square scan code/tag and solicits/waits to receive user registration information. In step 4, the scanning user 226 inputs Sherpa Square service registration information, which is bound to the SherpaSquareID value and stored at the server 200 (step5). Registration confirmation information/communication may be sent by application server 200 (step 6).

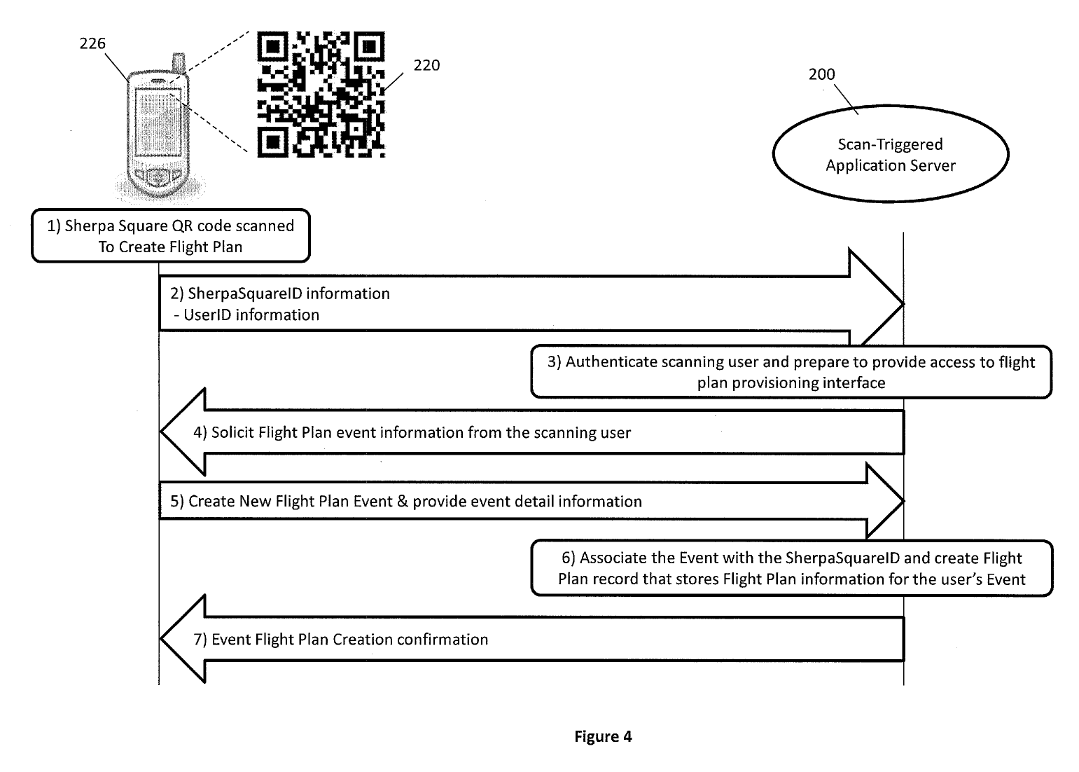

Presented in FIG. 4 is an exemplary use of Sherpa Square's Flight Plan Service by the registered owner of Sherpa Square 220. In this example, the registered owner of Sherpa Square 220 scans Sherpa Square QR code 220 with the user's mobile device 226 (step 1). When the registered owner scans the user's Sherpa Square QR code 220, user identifying information is communicated to application server 200 (step 2). Such user identifying information may, for example, be stored on the user/owner's mobile phone 226 in the form of a cookie, or other similar local data storage mechanism. Alternatively, the user may be prompted to manually input such user identifying information upon scanning of the user's Sherpa Square QR code. Also communicated to application server 200 as a result of the Sherpa Square scan is one or more identifiers referred to in this example as SherpaSquareID information. This SherpaSquareID identifier or group of identifiers is used to uniquely identify the Sherpa Square tag, and hence the associated backpack or other physical item and owner with which it has been affixed/associated. The identifier or group of identifiers may also be used, for example, to identify the retail merchant where the Sherpa Square tag and associated backpack were sold. In any event, once the user's identity credentials and the Sherpa Square ID information have been provided to application server 200, the user is authenticated/verified as the registered owner of Sherpa Square QR code 220, using the previously discussed binding record that was created during the registration process (step 3).

In step 4, the Owner is presented with a Flight Plan Service “dashboard” interface, through which can be provisioned information associated with an upcoming event. Exemplary events may include, but are not limited to, a hike, a wilderness outing, a kayak trip, a canoe trip, a biking trip, a sightseeing trip, a ski outing, a camping trip, a sailing trip, a trip to an urban destination (e.g., shopping mall, library, sporting event, concert, movie theater, etc.). The Flight Plan Service dashboard interface facilitates the creation, deletion and editing of Flight Plan information for such Events. Exemplary Flight Plan information that may be provisioned for an event is presented in Table 4 and includes, but is not limited to, a SherpaSquareID value 326 with which the event is associated, an event identifier 328, an event name 330, the starting date of the event 332, the starting time of the event 334, the starting location of the event 336 (e.g., nearby town name, trail/trailhead name, campground name, destination landmark/building name, etc.), the ending date of the event 338, the ending time of the event 340, the ending location of the event 342 (e.g., nearby town name, trail/trailhead name, campground name, destination landmark/building name, etc.), and a notification/alert delay time period 344 (e.g., 2 hours, 1 day, etc.).

Shown in Table 5 (FIG. 10B) is guardian information that may be associated with an event, which includes but is not limited to, SherpaSquareID identifier information 326, event identifier information 328, guardian identifier information 346, guardian contact addresses information 348 (e.g., email addresses, text message addresses, Twitter handles, instant messaging service addresses, etc.), and guardian name information 350. As used herein, term guardian refers to any individual or organization who is to be notified in the case where the Sherpa Square owner does not “close-out” an event within a prescribed window of time associated with an event (e.g., the owner goes on a hike for the weekend and does not return and “close-out” the hike event as scheduled). In one embodiment, the closing out of an event involves signaling server 200 with information that is sufficient for server 200 to determine that an event associated with a user has been concluded safely/as planned. As such, as part of the provisioning for an event, the associated owner essentially provides or specifies a guardian notification “trigger” for the event. When the scheduled event ends, a notification message will be communicated to some or all of the designated guardians if the “notification trigger” fires before the owner closes out the event (i.e., indicates that the event has concluded and they are safe). It will be appreciated that in various embodiments, such alert notification triggers may be specified in a number of different manners or formats. For example, a notification trigger may be specified as an event end time plus a notification/alert delay period (e.g., notification trigger time: event end time=10/1/2013 @ 10:00 am+notification delay period=1 hour), or a notification trigger may be simply specified as an alert notification time (e.g., notification trigger time=10/1/2013 @ 11:00 am).

In step 5-7, a Flight Plan record that includes at least some of the provisioned event information is created, associated with the SherpaSquareID and/or userID and stored by application server 200, and a Flight Plan Event creation confirmation message may be communicated from server 200 to the Owner.

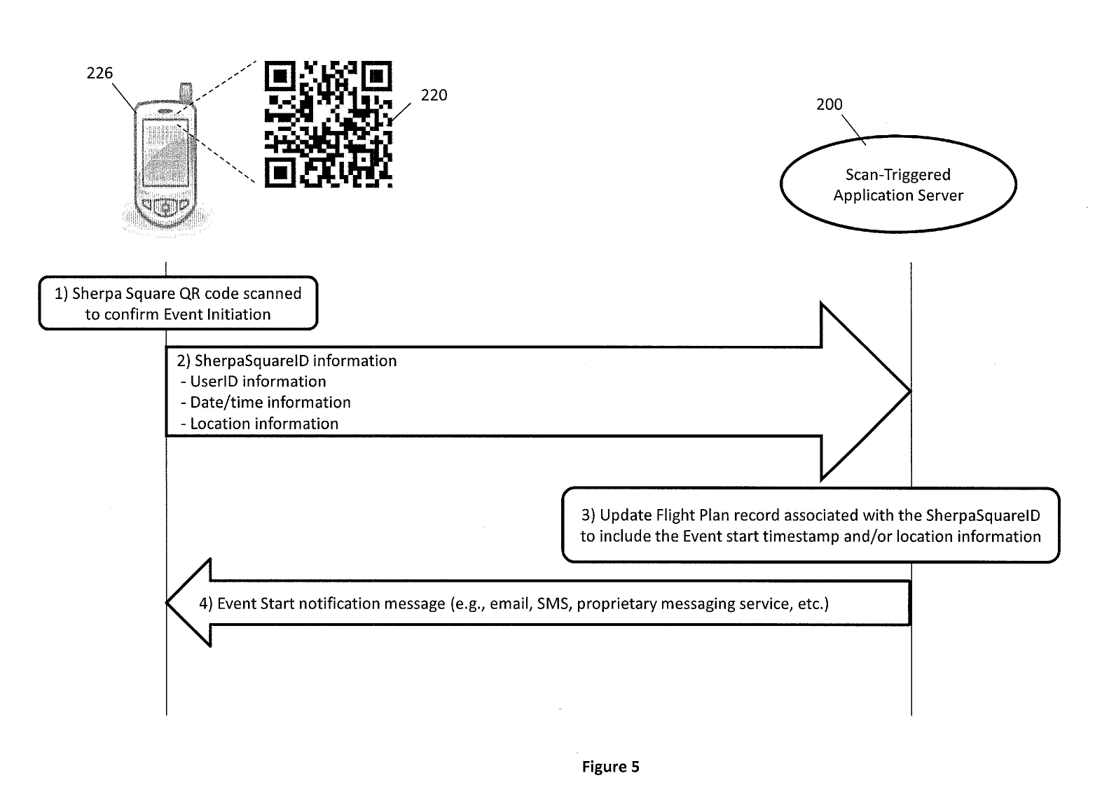

Presented in FIG. 5 is a process flow diagram which illustrates an exemplary scan-activated event initiation confirmation operational mode of the subject matter described herein. In this use scenario example, the registered owner of the Sherpa Square QR code tag has previously created and provisioned an event, as described above. When the provisioned start date of the associated event arrives, the owner who is ready to initiate the event (e.g., ready to begin a hike) scans Sherpa Square QR code tag 220 with mobile device 226. In a manner similar to that previously described, the scan by mobile device 226 causes user identifying information associated with the owner to be communicated to application server 200, either automatically or manually, and authenticated. The scan also causes SherpaSquareID information encoded in the QR code tag 220 to be extracted and communicated to application server 200. In one embodiment, application server 200 interprets the received SherpaSquareID and userID information as a signal that a previously provisioned event, which has an event start date/time that is proximal to the current date/time, has been initiated by the scanning user/owner. In other embodiments, the scanning user 226 may be prompted to specify the particular event that is being initiated. For example, server 200 may communicate a list of scheduled events to user 226 and display them as on-screen tap-able buttons. The user may tap the appropriate button, which causes event selection information to be communicated to server 200, where it is associated with the user and used to facilitate further Flight Plan service processing for the specified event.

In step 3, server 200 records date/time stamp information associated with receipt of the scan, and associates this “actual start” information with the stored event record. Exemplary Flight Plan transaction information is presented in Table 6 and includes, SherpaSquareID information 326, EventID information 346, event initiation timestamp information 352, and event closeout timestamp information 353. In other embodiments, the scanning user/owner may be asked for permission to access and obtain geo-location information from the mobile phone (e.g., GPS coordinates). In the event that GPS/geo-location information is obtained, this geo-location coordinate information may be provided to application server 200 and subsequently associated with the event record so as to generally improve/augment the accuracy of the previously provisioned Event Start Location information.

An event start confirmation message may be communicated to the Owner, as indicated in step 4. In an alternate embodiment, an event start confirmation message may also be communicated to some or all guardians that have been provisioned/associated with the event. The purpose of the event start confirmation message is, at least in part, to make the designated guardians aware that the owner is embarking on an outing for which they have been identified as “Guardians.”

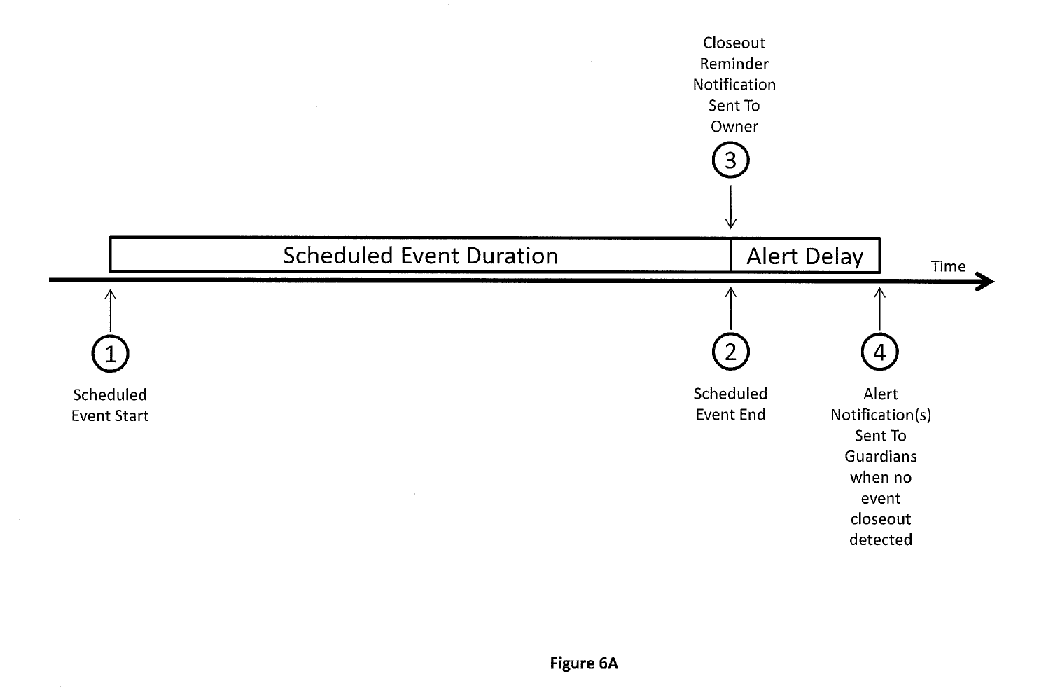

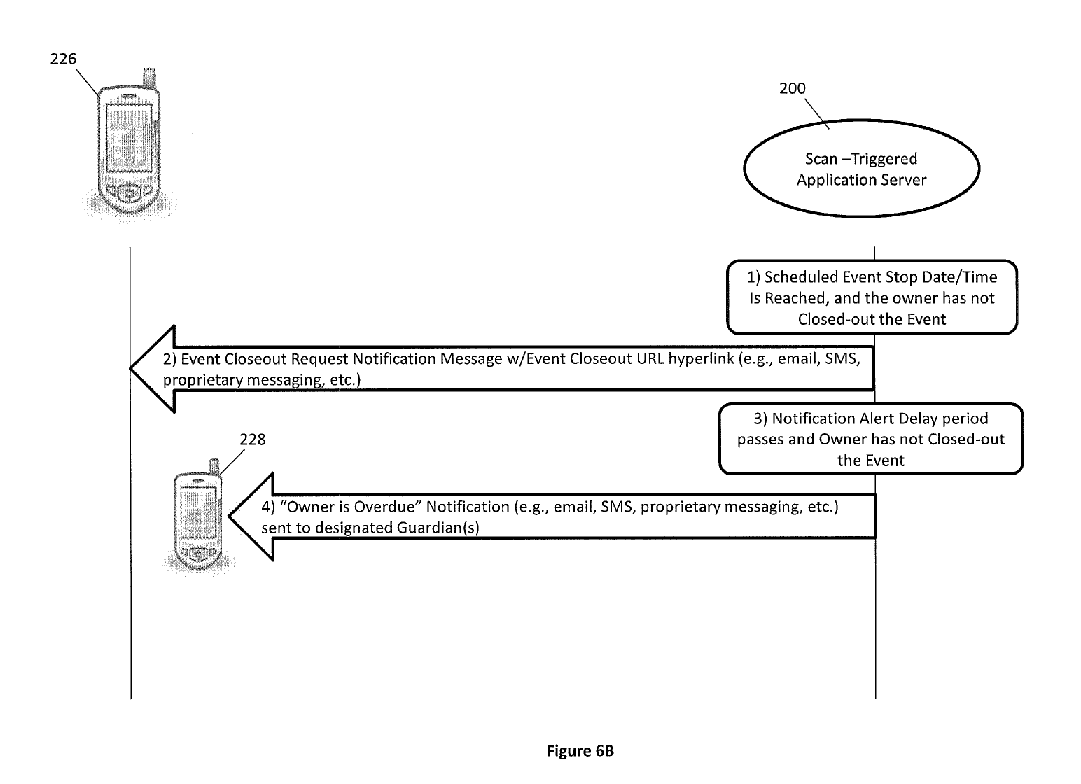

FIGS. 6A and 6B are diagrams which are intended to illustrate Sherpa Square Flight Plan Service related processing scenarios associated with an in-progress scheduled event. In step 1 of FIG. 6A, the start data/time for a previously provisioned event arrives. As discussed above, the Sherpa Square scan code/tag owner may optionally scan his or her Sherpa Square at initiation of the event to explicitly signal event initiation. In this example, it is assumed that no explicit event initiation scan is received by application server 200 from the owner. As such, application server 200 simply notes that the provisioned Event Start Date/Time has arrived, and assumes that the event is underway as planned. At the end of the scheduled event, step 2, application server 200 may generate and communicate an event “close-out” reminder message to the owner (step 3). The event close-out reminder message may be communicated using email, text message service, Twitter, and instant message service, or other proprietary or public messaging service. In one embodiment, the event close-out message may include an embedded uniform resource locator (URL) hyperlink which, when clicked or tapped by the owner, effectively notifies application server 200 that the owner has completed and closed-out the event.

In this example, for the purposes of illustration, it is assumed that the owner does not close-out the event once the Event End Date/Time pass. Accordingly, application server 200 monitors the passage of time since the scheduled Event End Date/Time and once an amount of time greater than or equal to the provisioned Alert Delay period has passed, Alert Notification messages are communicated to all provisioned guardians (step 4). Alert Notification messages may be communicated using email, text message service, Twitter, and instant message service, or other proprietary or public messaging service. The purpose of the Alert Notification message is to make the guardians aware that the Owner has not “checked-in” or acknowledged that the scheduled event has been successfully completed (i.e., the owner has not let everyone know that he/she is ok). Guardians will presumably take whatever action they deem necessary to either locate the owner and/or confirm that the owner is ok. FIG. 6B provides a supplementary view of such this same “failure-to-close-out” Event scenario, including the sending of Alert Notification messages to one (or more) provisioned guardians 228.

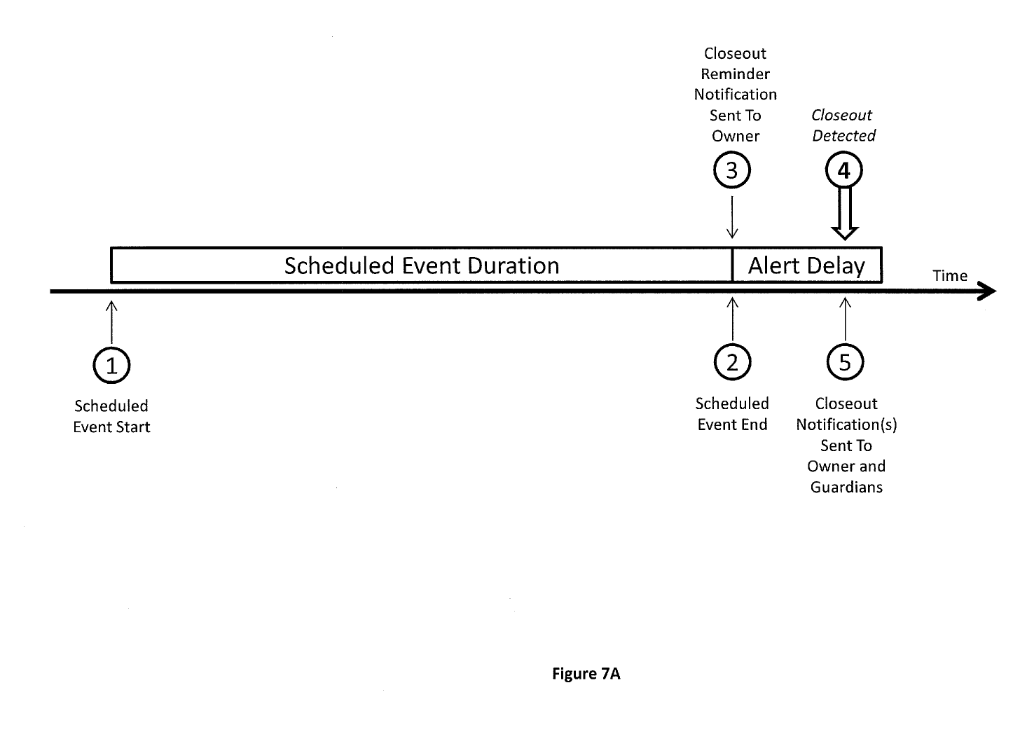

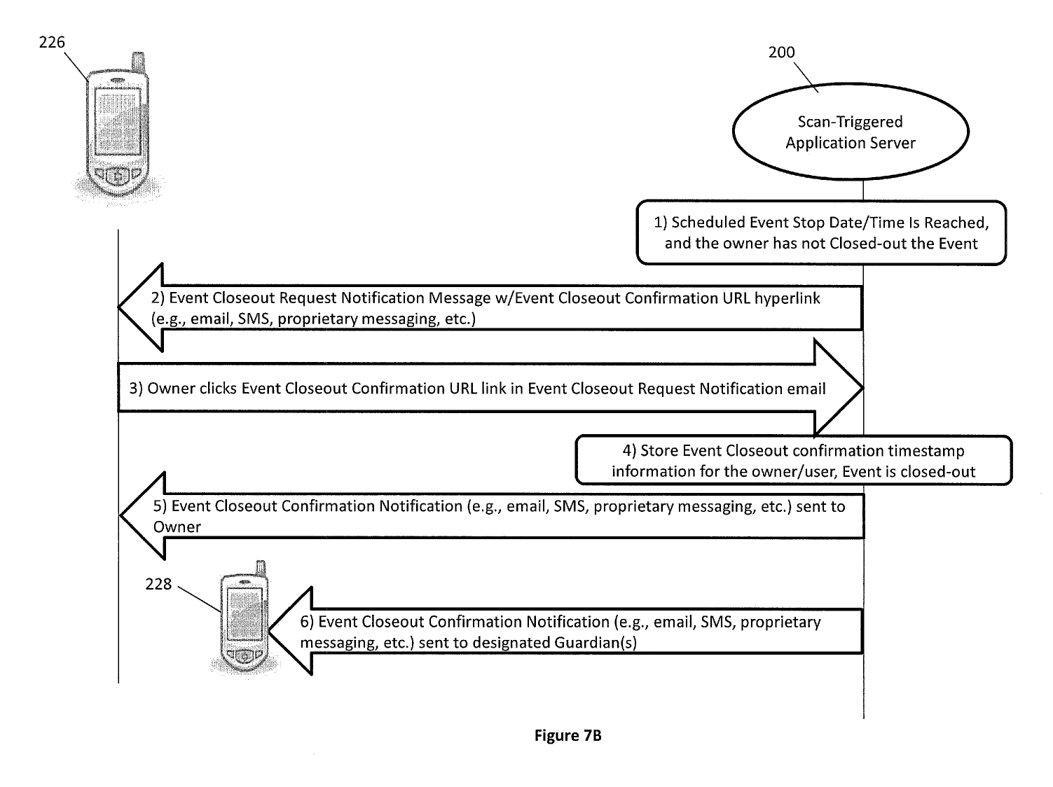

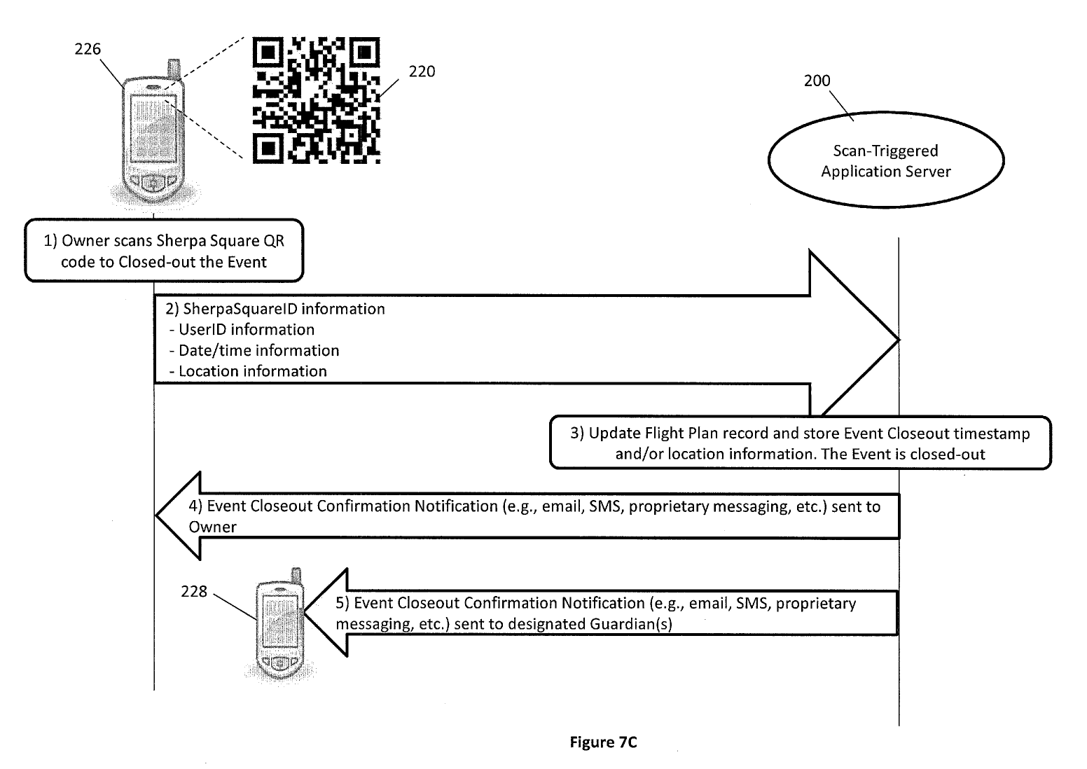

FIGS. 7A-7C are diagrams, which are intended to illustrate Flight Plan Service related processing associated with an in-progress scheduled event, where the owner closes-out the event prior to expiration of the provisioned Alert Delay period. In step 1 of FIG. 7A, the start data/time for a previously provisioned event arrives. As discussed above, the owner may optionally scan the owner's Sherpa Square at initiation of the event. However, in this example, it is assumed that no event initiation scan is received by application server 200. As such, application server 200 simply notes that the provisioned Event Start Date/Time has arrived, and assumes that the event is underway as planned. At the end of the scheduled event, step 2, application server 200 may generate and communicate an event “close-out” reminder message to the owner (step 3). In step 4, application server 200 detects/receives information that indicates that the owner has requested/initiated a close-out for the event. Application server 200 may receive such a close-out request from the owner in at least two ways. One way, mentioned previously and illustrated in FIG. 7B, is via the owner's clicking/tapping of a “close-out confirmation” hyperlink in a close-out reminder message sent by application server 200. In step 1, Sherpa Square hosting scan-triggered server 200 monitors the passage of time and determines that the user's provisioned event stop date/time has been reached and that no explicit event closeout signal has been received from the user. In step 2, server 200 generates a message (e.g., email, text message, etc.) that notifies the user that the event's scheduled stop date/time has arrived. In one embodiment, the notification message may include a clickable/tapable hyperlink that, when activated by the user, causes an event closeout signal/information to be passed to application server 200, such that the associated event can be identified and closed-out without further input/interaction from the owner. Alternatively, clicking or tapping of the hyperlink may cause application server 200 to present the owner with a Flight Plan Service dashboard interface which enables the owner to manually close-out the event. In step 5, event closeout confirmation information is communicated to the user/owner 226. In step 6, event closeout confirmation information is communicated to the user/owner's designated guardians 228.

In yet another approach illustrated in FIG. 7C, the owner may scan Sherpa Square QR code 220, and by scanning this QR code, sufficient cause sufficient information to be passed to application server 200, such that the associated event can be identified and closed-out without further input/interaction from the owner. In this embodiment, scan-triggered server 200 interprets receipt of the scan-extracted SherpaSquareID and associated UserID information as an implicit signal that the associated event has been closed out. In step 1, owner 226 scans his or her registered Sherpa Square scan code/tag 220. In step 2, SherpaSquareID information is extracted from the scanned scan code/tag and communicated to server 200 along with UserID information, in a manner similar to that described in previous embodiments. Date and time information, as well as user geo-location information (e.g., GPS coordinates, etc.) may also be communicated to server 200. In step 3, server 200 uses the received information to locate and update associated Flight Plan event record information, so as to close-out the “open” or active event. In one embodiment, server 200 may communicate a list of open events to the scanning user and request that the user specify the event which is to be closed-out. In step 4, event closeout confirmation information is communicated to the user/owner 226. In step 5, event closeout confirmation information is communicated to the user/owner's designated guardians 228.

Alternatively, scanning Sherpa Square QR code 220 may cause application server 200 to present the owner with a Flight Plan Service dashboard interface which enables the owner to manually close-out the open/active event.

It will be appreciated that in some embodiments of the Sherpa Square Flight Plan service, a user/owner may access the service by using any generic QR code scanner application or built-in QR scanning functionality on the user's mobile device (e.g., smartphone, computer integrated eyewear, wearable computer, tablet computer, etc.). In such cases, Sherpa Square scan codes may include encoded information that can be used by the QR scanner application or function to identify or locate the scan-triggered server that is hosting/providing Sherpa Square service. For example, the Sherpa Square scan code may include an encoded URL associated with the hosting Sherpa Square scan-triggered server or scan-triggered service provider. Exemplary information that identifies or can be used to identify a network server or host computer for providing Sherpa Square service may include, but is not limited to, a uniform resource locator (URL) and URL parameters, an Internet protocol (IP) address and port identifier. In other embodiments, a native application may be deployed on the scanning user/owner's mobile device which can perform some of the functions described/attributed to the scan-triggered server in the embodiments described above. As such, at least some of the functions and information associated with a Flight Plan event and associated processing may be performed locally on the user/owner's mobile device without departing from the scope of the subject matter described herein.

Presented in Tables 7 and 8 are exemplary data and data structures associated with a digital reward distribution capability that may be provided as a component of Sherpa Square Flight Plan Services described above. Digital rewards may include, but are not limited to, digital coupons that may be redeemed for goods and services, digital credits or tokens that may be redeemed for online entertainment services, such as online or downloadable video games and game assets/content, online streaming video, and online streaming or downloadable audio services. It will be appreciated that in various embodiments of the subject matter described herein, a digital reward may be allocated and distributed to the owner by application server 200 in response to any or all aspects of owner interaction with the scan-triggered Sherpa Square service. For example, a digital reward may be credited to the owner's Sherpa Square Flight Plan scan-triggered service account each time the owner provisions a new event, and/or each time the owner scan the owner's Sherpa Square QR code to start an event, and/or each time the owner scans his or her Sherpa Square QR code to close-out an event, and/or each time the owner clicks/taps a hyperlink to close-out an event, and/or each time the owner scans his or her registered Sherpa Square scan code/tag to access auxiliary online content (e.g., youth sporting game/practice schedules, youth sporting field condition information, etc.). Also, a reward may be credited to the account of the owner's guardian(s). If a guardian is not currently a registered Sherpa Square owner, then the guardian may be sent a message (e.g., email, text message, Tweet, etc.) that includes the digital reward or includes an incentive to become a registered Sherpa Square owner. Exemplary digital reward and digital reward distribution data is presented in Tables 7-8, and includes rewardID information 354, digital reward description information 356, digital reward expiration information 358, scanned SherpaSquareID information 326, Flight Plan eventID information 346, granted RewardID information 360, Reward grant date/timestamp information 362, and associated Reward redemption information/timestamp 363.

Embodiments of the subject matter described herein may be adapted to collect data and generate anonymized statistics related to event destination popularity stats, time-of-year attendance stats, digital reward redemption stats, general Sherpa Square use demographic stats, etc. Such data and stats may be logged/recorded and used to generate reports or provided to 3^{rd} party applications.

It will be appreciated that in various embodiments of the subject matter described herein, the SherpaSquareID information may be encrypted or obfuscated during communication from the mobile communication device to application server 200. In other embodiments, the information that identifies or can be used to identify a Sherpa Square application server may itself be encrypted or obfuscated when read by the QR code scanner, and may be subsequently decrypted/de-obfuscated by scan control logic module 112 so as to obtain the information necessary to identify the Sherpa Square application server to be contacted. Also communicated to the application server is information that identifies or can be used to identify the owner/registered user. This owner/registered user identifying information may be provided to the Sherpa Square application server 200 either before, after, or at the same time that the previously discussed scanned SherpaSquareID information is provided. For example, in one embodiment, the owner may log in (i.e., provide login credentials that are sufficient to identify and authenticate the owner) prior to scanning the Sherpa Square QR code, and application server 200 is adapted to associate the subsequently received SherpaSquareID information with the owner. Alternatively, the owner's UserID credentials may be provided at the time of/as a result of the Sherpa Square QR code scan, along with the SherpaSquareID information.

In one embodiment, Sherpa Square Flight Plan Control Logic Module 208 may determine (based on prior provisioned rules) whether the owner should be granted a digital reward in exchange for scanning the Sherpa Square code. If a reward is to be granted, Reward Control Logic Module 210 may facilitate the crediting of the granted reward to the owner's account.

Lost and Found Service

According to another aspect of Sherpa Square service, scan-triggered functionality is provided that is referred to herein as Lost and Found Service, which facilitates the return of a lost item to the associated registered owner (e.g., a hiker, biker, sailor, student, etc.). Lost and Found Service may be provided in tandem or conjunction with the above described Flight Plan service and may be activated/accessed by mobile phone or mobile computer (e.g., tablet) users via the use a scanner (e.g., QR code scanner, NFC scanner, RFID scanner, Bluetooth scanner, etc.) associated with the mobile device. More particularly, a Sherpa Square associated with Lost and Found Service is created and includes encoded information that can be used, at various times during the use cycle, to uniquely identify both a physical item (e.g., a backpack, hat, coat, gloves, mobile phone, tablet computer, or any physical item on which the QR code can be placed) and the owner to whom the item is registered. In one embodiment, such Sherpa Square codes may be deployed in the form of QR codes that may be displayed on the lock-screens of mobile electronic devices, such as mobile phones, tablet computers, notebook/laptop computers and wearable computers that include a visual display screen or visual display capability. It will be appreciated that (optionally) the same physical Sherpa Square QR code that is used to provide the Flight Plan Service described above may concurrently provide Lost and Found Service.

One exemplary use of Lost and Found Service might involve a merchant who would like to offer such service to consumers that purchase a backpack or other outdoor goods from the merchant's store. For example, a retail merchant may generate a Sherpa Square QR code tag for each backpack in the merchant's store, and affix these Sherpa Square QR code tags to each backpack. Exemplary Sherpa Square QR code tags may be metal “dog tag”-like tags, or may be “soft” tags (e.g., fabric, thin polymer, etc.) that can be affixed to each backpack by sewing/stitching, or via embroidering. Once a backpack is purchased, the associated Sherpa Square QR code tag is registered to the new owner via a registration process similar to that described previously in this disclosure. Once the Sherpa Square QR code tag is registered, the owner can scan the Sherpa Square QR code tag with the QR code scanner on the owner's mobile phone (or other mobile communication/computing device).

If Flight Plan Service and Lost and Found Service are not being concurrently provided by the Sherpa Square QR code, then scanning of the Sherpa Square QR code by the registered owner may, in one embodiment, simply log the owner into the owner's Sherpa Square account and display an associated dashboard interface where the owner can manage his/her account settings, view received digital rewards, redeem received digital rewards, and perform other tasks associated with Sherpa Square services. In another embodiment, scanning of the Sherpa Square QR code (if Flight Plan Service and Lost and Found Service are not being concurrently provided) may cause a digital reward to be issued/granted/credited to the registered owner's Sherpa Square scan-triggered service account. As described previously, digital rewards are similar to electronic coupons which may be redeemed by the registered owner for associated good, services, and online entertainment services/content.

If Flight Plan Service and Lost and Found Service are being concurrently provided by the Sherpa Square QR code, then scanning of the Sherpa Square QR code by the registered owner may lead directly or indirectly to the Flight Plan Service Event creation provisioning process, as described previously. By “indirectly”, it is meant that upon scanning the owner's QR code, the registered owner may be presented with the option to proceed to Flight Plan Service provisioning or proceed to a service settings interface or to simply receive a digital reward.

Owner registration provisioning of the Sherpa Square QR code 220 may also be accomplished via the methods previously illustrated in FIGS. 3A-3C, and consequently a detailed discussion of these registration methods will not be repeated here for the sake of brevity.

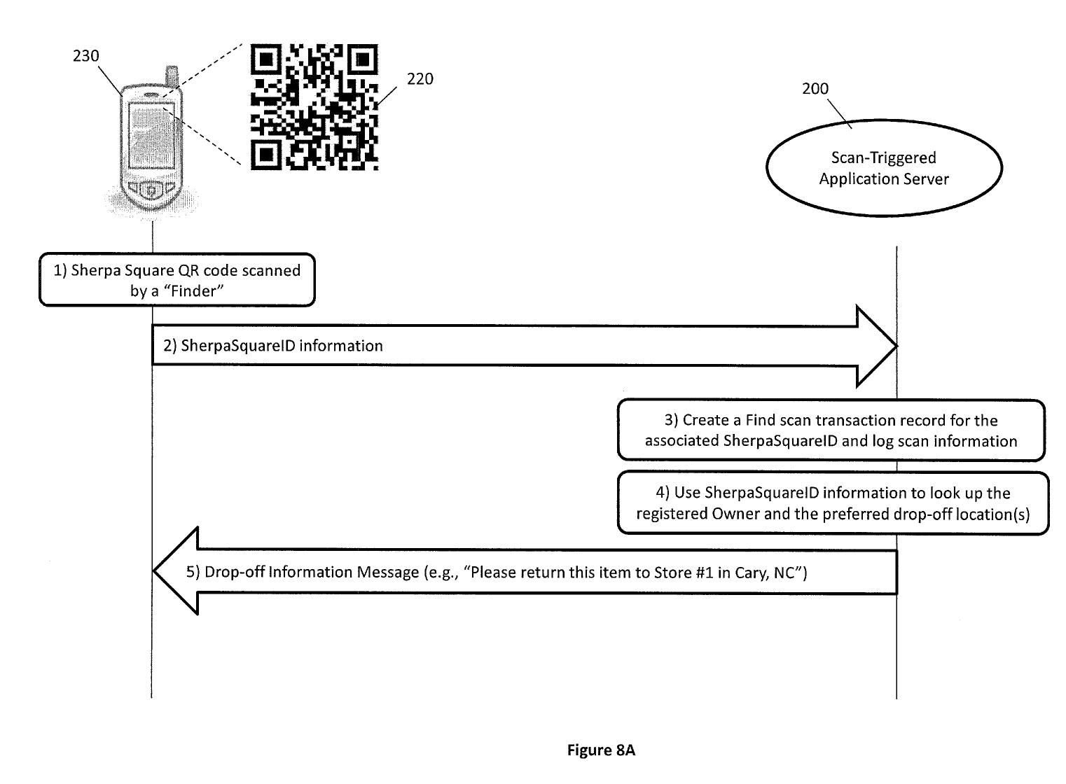

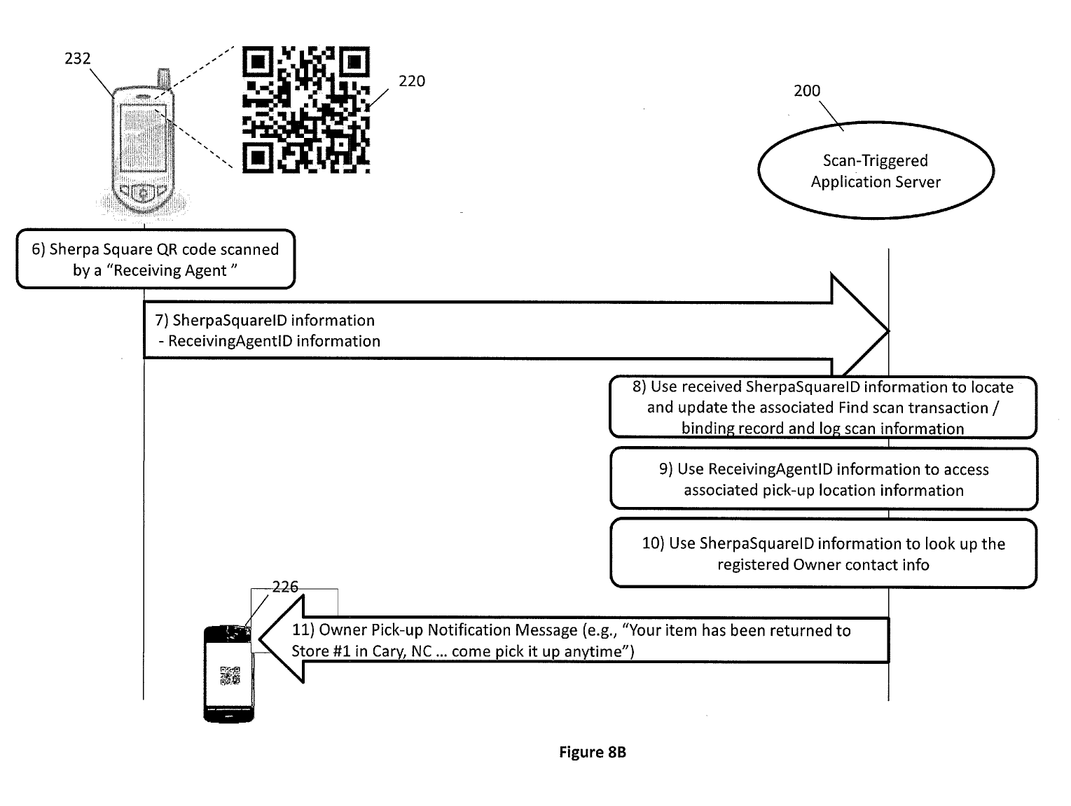

Presented in FIG. 8A is an exemplary use of Sherpa Square's Lost and Found Service by an individual, referred to herein as the “Finder,” who is someone other than the registered owner of Sherpa Square 220. In this example, the Finder scans Sherpa Square QR code 220 with the Finder's mobile phone 230. In this example, the Finder is also a registered user of the Sherpa Square Service and/or one of the other scan-based services offered by the scan-based services platform with which scan-triggered server 200 is associated. When the Finder scans the “found” Sherpa Square QR code 220, SherpaSquareID information is extracted from the scan code and communicated to scan-triggered server 200. This identifier or group of identifiers is used to uniquely identify the Sherpa Square tag, and hence the associated backpack or other physical item with which it has been affixed/associated. The identifier or group of identifiers may also be used, for example, to identify the retail merchant where the Sherpa Square tag and associated backpack were sold, or an organization or organizational entity with which the owner is associated, such as a youth sporting team, a non-profit organization, a children's museum, retail business, a photo hosting/sharing site, etc. If the Finder were, coincidentally, a registered user of the scan-triggered services platform with which server 200 is associated, UserID information associated with the Finder may also be communicated to server 200 where it is associated with and stored in a “Find” record related to the found Sherpa Square tag/code.

In any event, once the found SherpaSquareID information has been provided to application server 200, a “Find” record is created which associates the Finder, timestamp information associated with the Finder's scan and the Sherpa Square ID information (step 3). This Find record is stored by application server 200, and is used to access/locate contact information for the registered owner of Sherpa Square QR code 220, using the previously discussed owner registration binding record that was created during the owner's registration process (step4). Exemplary Find event record information is illustrated in Table 9 (FIG. 10C) and includes SherpaSquareID identifier information 326, a Find record identifier 364, optional Finder UserID identifier information 366, Find-scan timestamp information 368, and optional Find location information 370 (e.g., GPS coordinate information associated with the location of the scan by the Finder's mobile device). In addition to determining the registered owner associated with the scanned Sherpa Square QR code 220, application server 200 also may lookup/access the owner registration binding record to obtain the owner's preferred drop-off/pick-up information. In step 5, drop-off location information, which may include the owner's preferred drop-off location is communicated to the Finder. Exemplary drop-off location information message formats may include, but are not limited to, an on-screen message, an email message, a text message, a Tweet, an instant message service message, etc.

It will be appreciated that in one embodiment, application server 200 also may lookup/access the owner registration binding record to obtain information that identifies the retail store location where the item (e.g., backpack, bicycle, hat, etc.) was purchased. In some cases, this retail store location information may serve as the default drop-off location, and may be communicated to the Finder in the manner described above. In some cases, multiple drop-off location options, including the default drop-off location, may be communicated to the Finder. In yet another embodiment, application server 200 may ask the Finder for information that provides insight into the Finder's current location. For example, in response to scanning QR code 220, application server 200 may ask the Finder for his/her current GPS coordinates, or may ask the Finder to input the zip code of the Finder's current location, etc. Once this geo-location information is collected from the Finder (or the Finder's phone's GPS), application server 200 may use this information to determine a suitable/convenient drop-off location, and communicate this drop-off location information to the Finder. For example, once the Finder has provided his/her geo-location information, application server 200 may search a directory of public drop-off or “registered” drop-off locations and select one or more of the most convenient/closest, to which the Finder is directed to proceed to and drop-off the lost item. Exemplary public or “registered” drop-off locations may include, but are not limited to, police stations, sheriff's offices, fire stations, public libraries, public schools, government offices, post offices, packing/shipping stores, participating retail store locations, etc. It will be appreciated that one of the advantages of the Lost and Found Service of the subject matter described herein is that the Finder and the owner are never made to be in direct contact with one another. This is desirable to prevent an unscrupulous Finder from luring the owner of a lost item into an unsafe location/situation. Consequently, arranging for a drop-off at a public/secure drop-off location (e.g., retail store location, police station, public library, etc.) affords a great deal of safety for registered owners/users of the Sherpa Square Lost and Found Service. It will also be appreciated that the owner's personal information (e.g., name, address, phone number, etc.) is never disclosed to the Finder, which provides an increased degree of safety.

Shown in FIG. 8B is a process diagram associated with the returning of a “lost” item associated with Sherpa Square QR code 220. In this example, the Finder who was instructed to return the lost item to a designated drop-off, and consequently delivers the lost item (along with the associated Sherpa Square QR code tag 220) to the designated drop-off location. It is assumed, in this example, that the designated drop-off location is the retail store location where the item was originally purchased, and where the Sherpa Square QR code 220 was originally registered by a Registration Agent associated with the retail store. In one embodiment, for the purposes of drop-off processing, a Registration Agent is also considered by application server 200 to be a “Drop-off Receiving” Agent. It will be appreciated that in other embodiments; a Registration Agent may or may not also be designated as a Drop-off Receiving Agent. In some embodiments, a Drop-off Receiving Agent may be registered separately from Registration Agents via a process that is very similar to the process previously described. For instance, a sales associate at a retail store may be provisioned in application server 200 to be an authorized Drop-off Receiving Agent, where the retail store location and other information may be associated with a Drop-off Receiving Agent binding record that is created and stored at or by application server 200. In this example, Drop-off Receiving Agent 232 receives the lost item and associated QR code tag 220 from the Finder and scans the Sherpa Square QR code 220 (step 6).

When the Drop-off Receiving Agent 232 scans the “found” Sherpa Square QR code 220, ReceivingAgentID identifying information associated with the Receiving Agent is communicated to application server 200 (step 7). Such ReceivingAgent identifying information may, for example, be stored on the Drop-off Receiver Agent's mobile phone 232 in the form of a cookie, or other similar local data storage mechanism. Alternatively, the Drop-off Receiver Agent 232 may be prompted to manually input such identifying information upon scanning of the “found” Sherpa Square QR code. Also communicated to application server 200 as a result of the Sherpa Square scan is one or more identifiers referred to in this example as SherpaSquareID information. This identifier or group of identifiers is used to uniquely identify the Sherpa Square scan code/tag, and hence the associated backpack or other physical item and registered owner with which it has been affixed/associated. The identifier or group of identifiers may also be used, for example, to identify the retail merchant where the Sherpa Square tag and associated backpack were sold. In any event, once the Receiving Agent's credentials and the Sherpa Square ID information have been provided to application server 200, the Drop-off Receiving Agent is authenticated and, in one embodiment, the associated Find record is located and updated to include information associated with the Receiving Agent scan. Alternatively, a “Drop-Off” record may be created and stored, which associates the Drop-off Receiving Agent, timestamp information associated with the Receiving Agent's scan and the Sherpa Square ID information (step 8). In step 9, the Receiving Agent identifying information is used by server 200 to access provisioned Receiving Agent profile information and obtain “pick-up” location information associated with the scanning Receiving Agent. For example, a retail employee who has been provisioned as a Receiving Agent may have a pick-up location associated with the Receiving Agent's profile, which is the particular store location where the Receiving Agent works. In such a case, server 200 is able to use received Receiving Agent identification information to implicitly determine where the “found” item was returned and, consequently, should be picked-up by the registered owner. In other embodiments, the scanning Receiving Agent may receive from server 200 a list of possible “pick-up” locations from which the Receiving Agent may make a selection. In an alternative embodiment, the Drop-off Receiver Agent may be prompted to provide or to allow his/her mobile phone to provide current GPS coordinate information which may be used by application server 200 to help identify the drop-off/pick-up location.

In any event, once the correct/appropriate pick-up location has been determined or specified, server 200 is adapted to use the received SherpaSquareID information to locate the associated owner binding record from which owner contact information (e.g., email address, text message service address, Twitter handle, social media account message posting address, etc.) is obtained, as well as optional information that may described the item with which the SherpaSquareID has been associated (e.g., “Little Timmy's backpack, Cindy Lou's water bottle, etc.), as indicated in step 10.

Exemplary drop off event record information is illustrated in and Table 10 and includes SherpaSquareID identifier information 326, FindID record identifier information 364, ReceivingAgentID information 372, ReceivingAgent scan timestamp information 374, drop-off/pick-up location information 376.

In response to the Receiving Agent scan, server 200 generates a “Ready For Pickup” notification message that includes information which identifies the pick-up location and communicates this information to the registered owner 226 (e.g., via email, text message service, instant message, Twitter, social media account message post, etc.) of the associated Sherpa Square QR code 220 (step 11).

In one embodiment, application server 200 may issue/grant/credit the account of the registered owner of Sherpa Square QR code 220 with a digital reward when the lost item is scanned by a Receiving Agent. In another embodiment, the registered owner of Sherpa Square QR code 220 may receive a digital reward when the owner scans his or her own QR code. Exemplary digital reward data is presented in Table 11 and includes SherpaSquareID identifier information 326, FindID record identifier information 364, granted digital reward identifier information 378, reward grant timestamp information 380, reward redemption timestamp information 381.

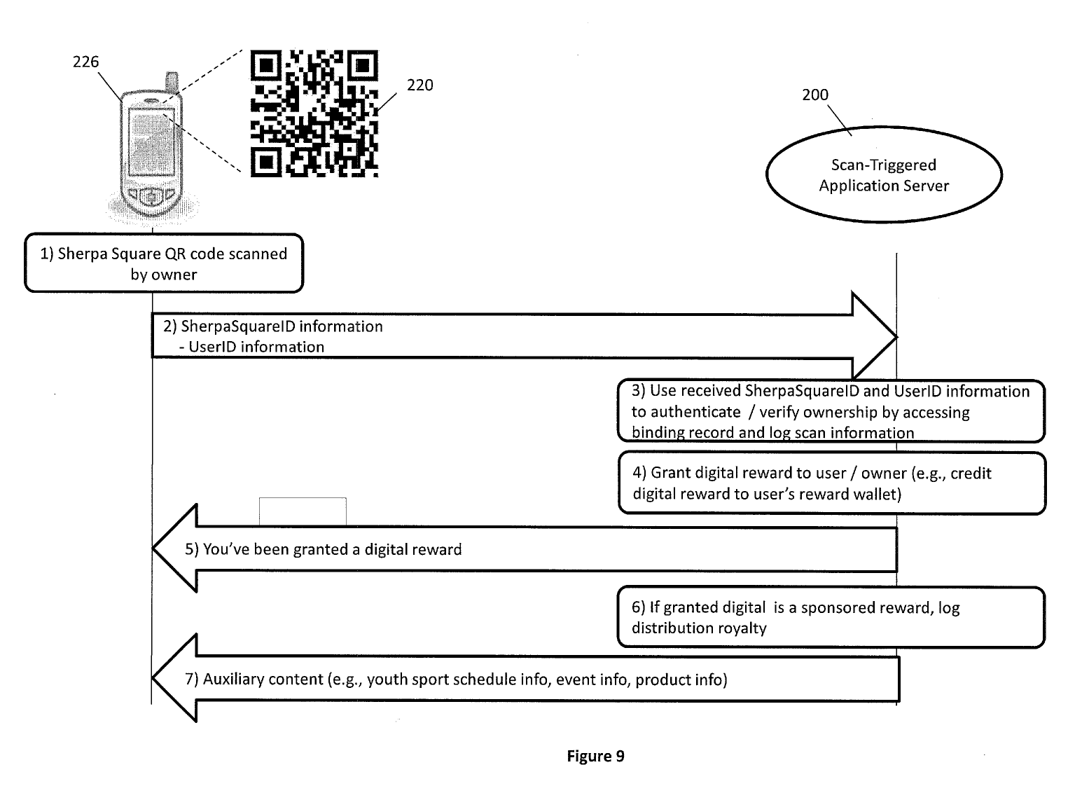

Presented in FIG. 9 is an exemplary embodiment of digital reward distribution services that may be provided by scan-triggered server 200 in response to receipt of scan-related information resulting from the scanning of a scan-triggered service code, such as a Sherpa Square scan-triggered service code. It will be appreciated that the embodiment illustrated in FIG. 9 describes processing operations and information flows associated with the providing of Sherpa Square services, but the following discussion of scan-triggered reward distribution services is in no way limited to Sherpa Square scan-triggered service, but instead may be deployed in conjunction with any scan-triggered service provided by a scan-triggered server that is adapted to host/provide scan-triggered services to users.

In step 1, the registered owner of Sherpa Square scan code/tag 220 uses the owner's mobile device 226 to scan code 220. In step 2, scan-triggered service code information, such as SherpaSquareID information is extracted from code 220 and communicated to scan-triggered server 200. Scan triggered service code information is used, at least in part, by the hosting scan-triggered server to determine the hosted scan-triggered service that is to be provided to the scanning user. In this example, the scan-triggered service is Sherpa Square service and the extracted SherpaSquareID information is used by server 200 to identify the requested scan-triggered service. User identifying information may also be provided to server 200 in a manner similar to that previously described in this disclosure. In step 3, server 200 uses the received SherpaSquareID and UserID information to access Sherpa Square service information, such as Sherpa Square service binding record information, which is used to provide the requested/associated Sherpa Square service(s). In step 4, server 200 determines that the scanning user/owner should be granted a digital reward and may, for example, credit a digital reward to a digital reward wallet associated with the user's scan-triggered service account. In step 5, the scanning user is notified of the digital reward credit and may browse/access the user's digital reward wallet to access credited rewards.

Shown in step 6 is additional processing that may be performed by server 200 in the case where the granted digital reward is of a special type, referred to herein as a sponsored reward. Sponsored rewards are digital rewards which may be distributed by or on behalf of a sponsored entity to users associated with the sponsored entity. Associated with a sponsored reward is a sponsoring entity. For example, a sponsored entity may be a non-profit organization and a sponsoring entity may be a retail business. In other deployment scenarios, a sponsored entity may, for example, be a first retail business entity while the sponsoring entity may be a second retail business. In one embodiment, associated with a sponsored reward is a royalty term or fee. Exemplary royalty terms or fees may include, but are not limited to, a royalty fee payable for rewards distributed to a scan-triggered service user, a royalty fee payable for rewards redeemed by a scan-triggered service user, a royalty fee payable for a fixed reward distribution period, and a royalty fee payable for reward distribution to a specified user demographic (e.g., geographic location, gender, age, activity preference, shopping preference, shopping history, etc.). Exemplary sponsored digital reward information is shown in Table 12 and includes RewardID identifier information 382, Sponsoring entity identifier information 384, Sponsored entity information 385, reward description information 386, reward expiration information 388, reward sponsorship royalty term information 390.

In one embodiment, a provisioning interface associated with scan-triggered service platform 200 is adapted to facilitate to creation and subsequent distribution of sponsored rewards to users of the scan-triggered service platform. In one embodiment, a sponsoring entity may create a digital reward that may be offered to a sponsored entity. In one embodiment, royalty terms associated with the sponsored reward may be negotiated between the sponsoring and sponsored entities via the provisioning interface of the scan-triggered service platform. Once sponsorship terms acceptable to both the sponsoring and sponsored parties are agreed upon, platform/server 200 facilitates the distribution and redemption of the sponsored rewards to scan-triggered service users. As indicated in step 6 of FIG. 9, server 200 is adapted to maintain sponsored reward accounting records that, in one embodiment, may facilitate the creation of royalty invoices and associated record keeping/tracking information. In one embodiment, scan-triggered service platform may serve as a royalty payment collections clearinghouse between sponsoring and sponsored entities, thereby receiving and disbursing funds associated with royalty payments and providing the necessary accounting/record keeping.

A detailed discussion of sponsored rewards and exemplary scan-triggered service platform embodiments for providing such sponsored services is provided in previously filed U.S. Provisional Patent Application Ser. No. 62/001,673, filed May 22, 2014; the disclosure of which is incorporated herein by reference in its entirety.

In step 7, in response to the scanning of the user's own, registered Sherpa Square scan code 220, user/owner 226 is provided with auxiliary information content. Exemplary auxiliary information content may include youth sport schedule information, such as game schedule information, practice schedule information, youth sporting field condition information, youth sporting game and/or practice location information, no-profit event schedule information, etc. Auxiliary information content may include URL hyperlink information content, or linked access to other online content or online resources.

It will be appreciated with regard to the Sherpa Square service embodiments described above that such services may also be provided via a native Sherpa Square application that is installed on the user's smartphone. In such cases, information that identifies or can be used to identify the address of a Sherpa Square server to which the appointment information should be communicated need not be encoded within the Sherpa Square QR code that is displayed to and scanned by an owner. In such native application deployments, the information that identifies or can be used to identify the address of a Sherpa Square server may be pre-configured and stored in the smartphone's memory, such as in data storage module 116. Alternatively, the native application may dynamically determine the address of the appropriate Sherpa Square server at the time of the Sherpa Square QR code scan by the Owner. In such scenarios, Sherpa Square processing is very similar to that described above, except that the address of the Sherpa Square server is not obtained by a user scan of a Sherpa Square QR code.

According to another aspect, the subject matter described herein includes a system for creating and distributing sponsored digital rewards by a scan-triggered application server. The system includes a computing platform including a processor; a server application module executable by the processor. The server application module is configured to receive, from a scan-enabled client module associated with a user, scan-triggered service identifying information obtained from the scanning of a scanable code by a user. The server application module is further configured to distribute a sponsored digital reward to the user. The server application module is further configured to maintain a record of a sponsorship royalty associated with the distributed digital reward.

According to another aspect, the subject matter described herein includes a method for creating and distributing sponsored digital rewards by a scan-triggered application server. The method includes receiving, from a scan-enabled client module associated with a user, scan-triggered service identifying information obtained from the scanning of a scanable code by a user. The method further includes distributing a sponsored digital reward to the user. The method further includes maintaining a record of a sponsorship royalty associated with the distributed digital reward.

Parking Reminder Service

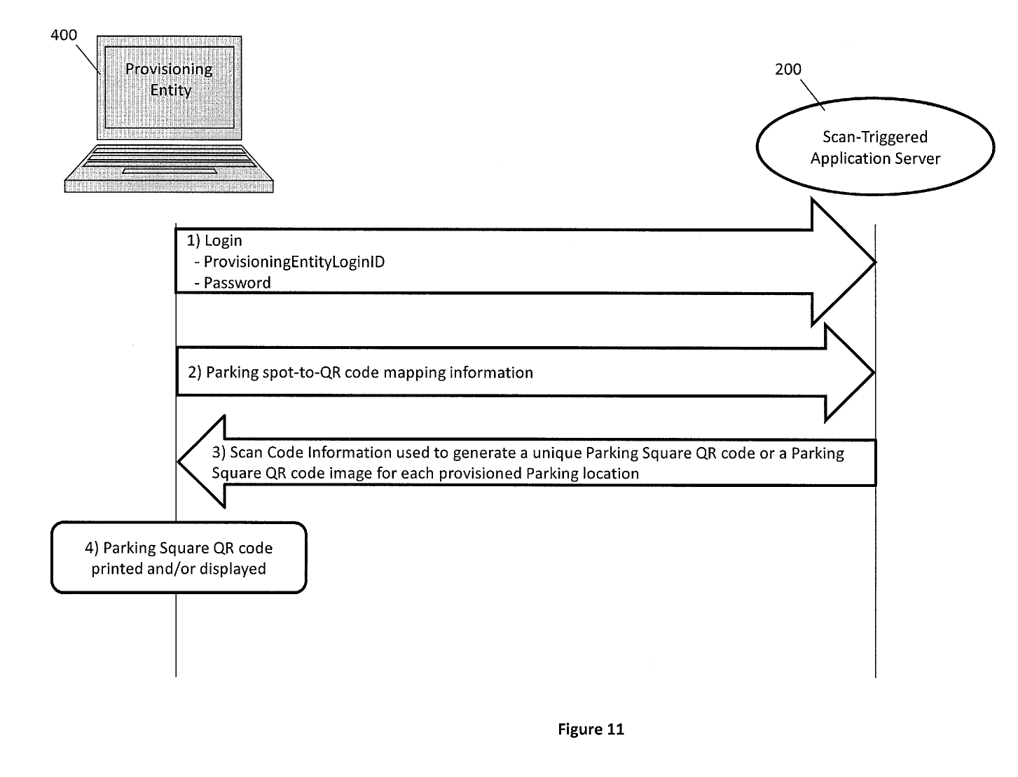

Shown in FIG. 11 is diagram that generally illustrates the provisioning of information associated with one embodiment of a service of a scan code-based service system according to an embodiment of the subject matter described herein. This service is referred to herein as Parking Reminder Service, which is a scan-based service that enables a service user entity (e.g., a traveler, shopper, etc.) to create and store a “parking reminder” during an excursion (e.g., trip to the airport, trip to the shopping mall, trip to a theme park, trip to a concert event venue, etc.). Parking Reminder Service may be activated/accessed by mobile phone or mobile computer (e.g., tablet) users via the use a scanner (e.g., QR code scanner, NFC scanner, RFID scanner, Bluetooth scanner, etc.) associated with the mobile device. More particularly, a scanable QR code, referred to herein as a Parking Square, associated with Parking Reminder Service is created and includes encoded information that can be used to uniquely identify a parking location.

One exemplary use of Parking Reminder Service might involve an airport authority who would like to offer such service to travelers using the airport. In one embodiment, a unique Parking Square QR code is generated for and associated with each parking spot/location in the airport's parking areas. These Parking Square QR codes are then displayed in or near their associated parking spots. In one exemplary deployment, each Parking Square QR code may be painted/stenciled in or near the parking spot with which it is associated. In this disclosure, Parking Square scan-codes that are associated with individual parking spots are referred to as “specific” Parking Square scan-codes.

Similarly, a unique Parking Square QR code may also be generated for and associated with each row of parking spots and these row-based Parking Square scan codes may be displayed (e.g., painted/stenciled, via stickers, via signs, etc.) at or near their associated parking rows. It will be appreciated that unique Parking Square QR code may also be generated for and associated with different “general” areas, in addition to parking rows. For example, a unique Parking Square QR code may be generated for and associated with a parking lot, a level in a parking garage, etc. In this disclosure, Parking Square scan-codes that are associated with areas more general/less specific than individual parking spots are referred to as “proximity” Parking Square scan-codes.

In various embodiments of the subject matter described herein, specific-type and proximity-type may be deployed and used in concert within the same deployment site (e.g., airport, shopping mall, theme park, concert event venue, etc.).

A user, for instance a traveler at an airport parking facility, parks his or her car in a parking space within the airport parking facility and uses the QR code scanner on the user's mobile phone to scan the Parking Square QR code that is displayed at the user's parking space. Information extracted from the scanned Parking Square QR code is communicated to a network-based application server that provides the associated Parking Reminder Services. Also communicated to the application server is information which can be used to identify the user. Once this information is received, the Parking Reminder Services application server creates and stores a parking reminder binding record, which includes information that can be used to identify both the user and the associated parking location identifier information. The application server may be pre-provisioned with information that associates each “specific” parking location identifier with the appropriate “proximity” identifiers, as well as other information, such as parking facility name and location information, etc. As such, in this case, the parking reminder binding record that is created and stored by the application server includes information sufficient to identify the specific parking space where the user parked and potentially other information, such as the date and time that the parking reminder was set.

In one embodiment, when the user returns to the airport at the conclusion of his or her travels, the user simply scans any Parking Square QR code at the airport/in the parking facility and information which identifies the user is communicated to the application server. The application server uses the user information to locate/access the user's parking reminder binding record(s). In one embodiment, the most recently set parking reminder/parking space information is returned and presented to the user. In another embodiment, when the user scans any Parking Square QR code in the parking facility, application server queries the user to determine whether they are attempting to create a new parking reminder or whether they would like to view previously set parking reminders. The application server responds appropriately, as described above, according to the user's input/response.

In an alternate embodiment, when the user returns to the airport at the conclusion of his or her travels, the user simply scans a Parking Square QR code at the airport/in the parking facility that is specially configured to serve as a parking reminder “retrieval” scan-code, and information which identifies the user is communicated to the application server. The application server uses the user information to locate/access the user's parking reminder binding record(s). In one embodiment, the most recently set parking reminder/parking space information is returned and presented to the user. In this embodiment, there is no need for the application server to query the user's intent regarding the setting or retrieval of a parking reminder, as it is implicit.

In various embodiments of the subject matter described herein, the user may be issued or granted a participation reward, such as an electronic coupon, upon some or all scans of a Parking Square QR code. Such participation rewards may be distributed and credited to the user's Parking Reminder Service account or other scan-based services user account associated with the services platform. The application server may facilitate, monitor, and track participation reward redemption associated with participating vendors and merchants.

Returning to FIG. 11, a provisioning entity 400 is adapted to provision parking location information for an associated parking facility (e.g., Raleigh-Durham International Airport (RDU)), as indicated in step 1. Exemplary provisioned parking location information is generally illustrated in Tables 14-15 and includes ParkingSquareID identifier information 518, parking facility name information 520, parking lot identifier information 522, parking level information 524, parking area information 526, parking row information 528, and parking space information 530. Each “specific” parking space or more general “proximity” area (e.g., a parking row, parking deck level, etc.) with which a scanable Parking Square QR code is to be associated is provisioned via Parking Reminder control module 218 of scan-triggered application server 200 (step 2). Parking Square QR codes for each provisioned specific parking space or proximity parking area are generated by application server 200 (step 3) and these QR code may be displayed (e.g., painted/stenciled on pavement or parking columns/pillars, via signs, via engraved plaques, via computer/TV monitors, etc.) at the associated parking facility in the appropriate/associated parking locations (step 4).

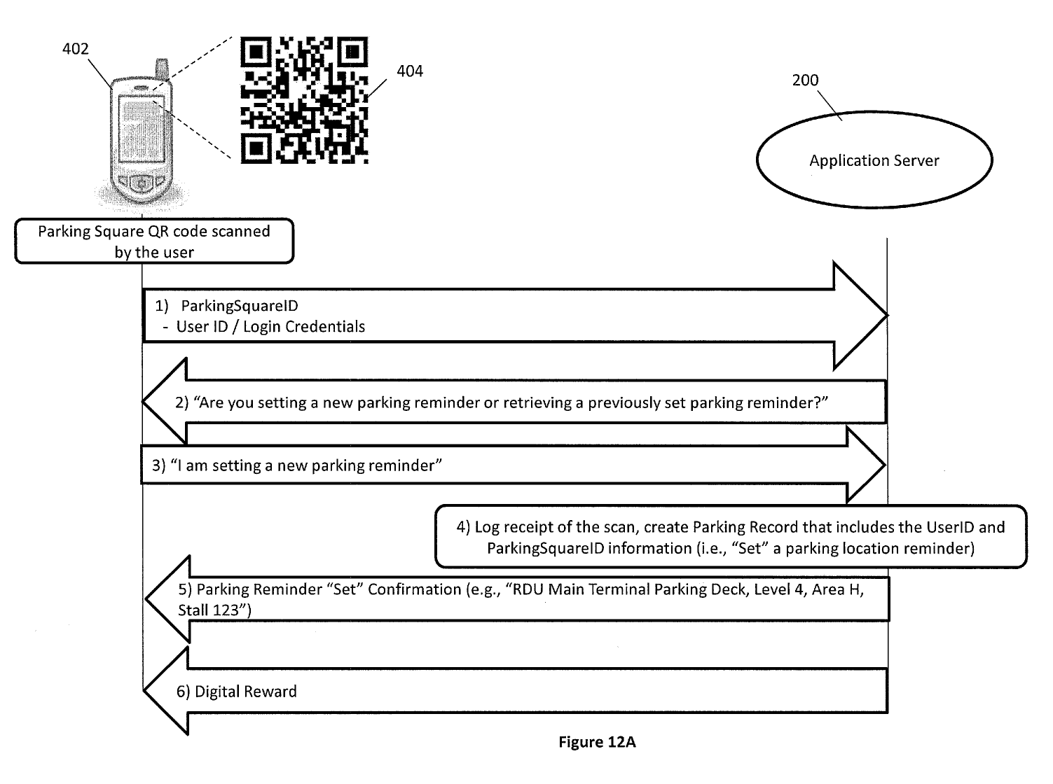

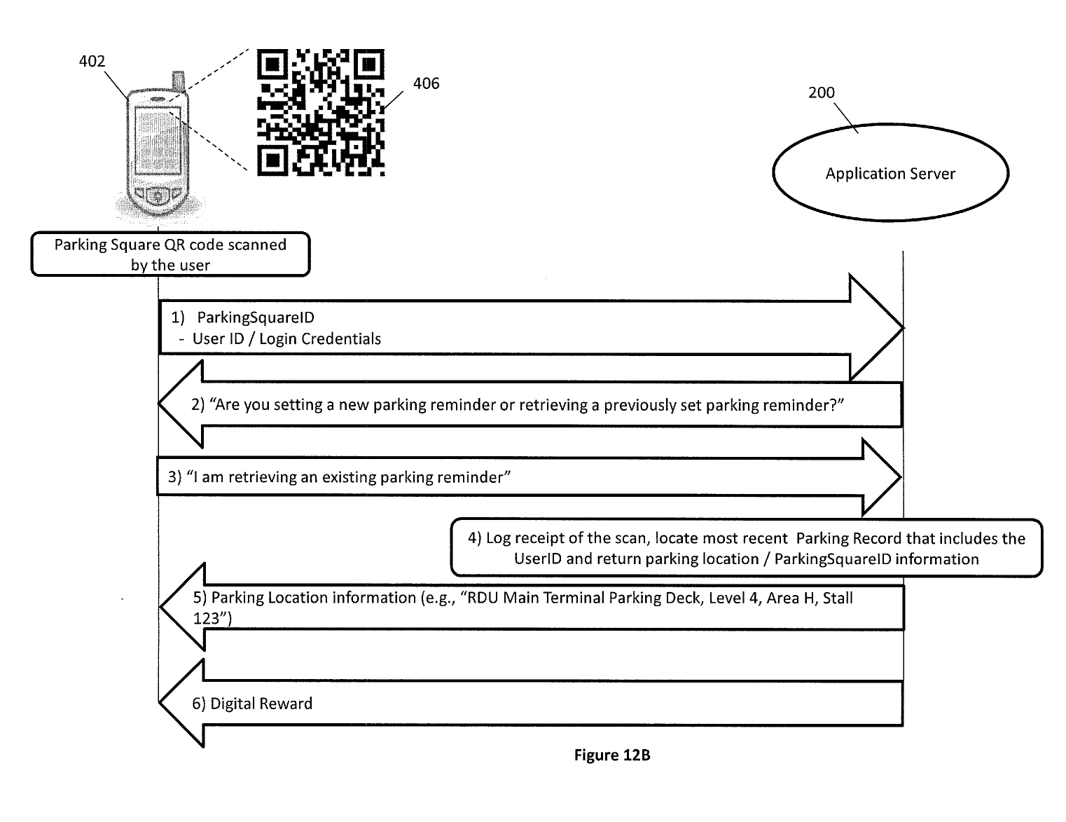

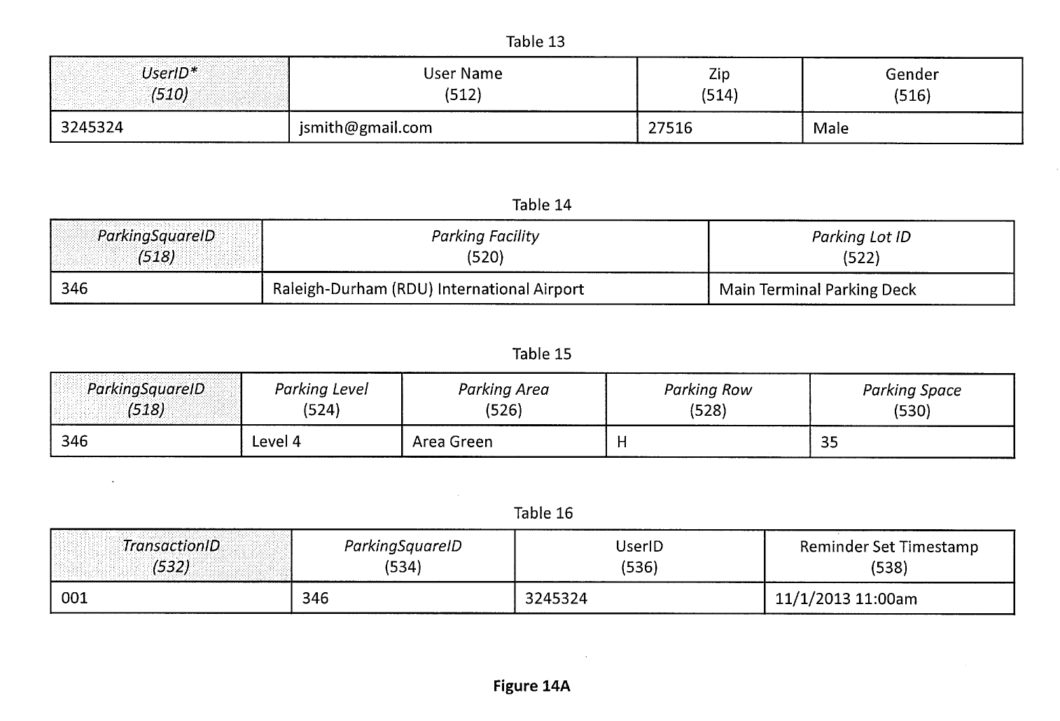

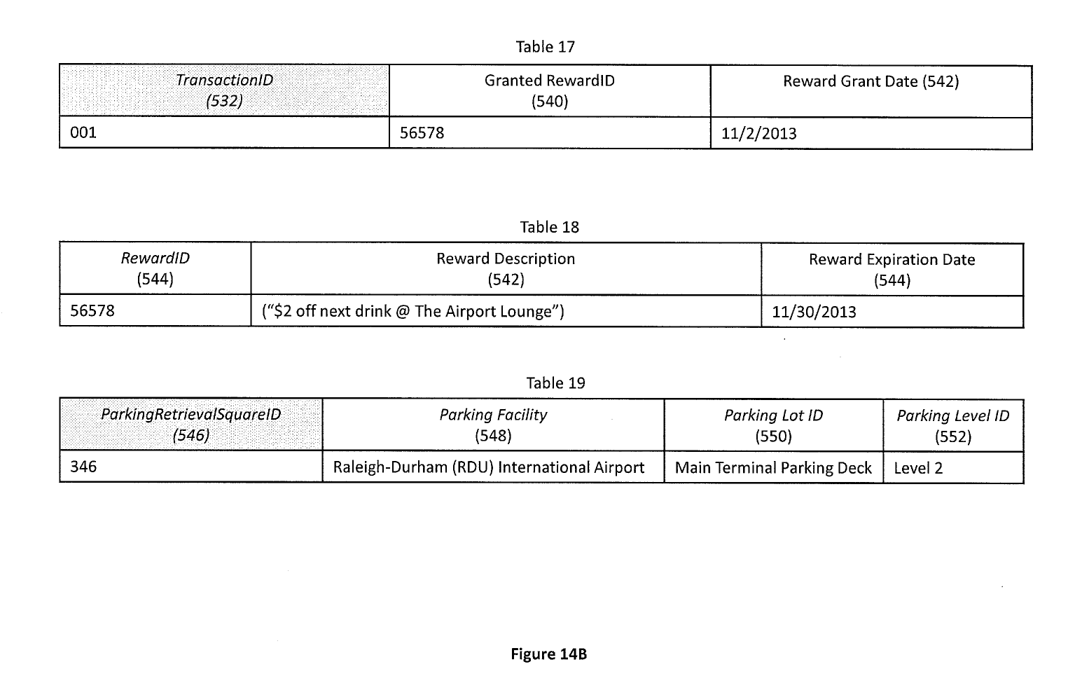

In FIG. 12A a Parking Square QR code 504 is scanned by a user's mobile communication device 502 once the user has selected a space and parked. In step 1, the scanning user's login credentials are communicated to application server 200. Exemplary user information is presented in Table 13 (FIG. 14A) and includes UserID information 510, user name information 512, user address information 514, and user gender information 516. Such user identifying (e.g., UserID) information may, for example, be stored on the user's mobile device 402 in the form of a cookie, or other similar local data storage mechanism. Alternatively, the user may be prompted to manually input such user identifying information upon scanning of a Parking Square QR code. If the scanning user is not a registered user of the scan code-based services platform, then user registration processing may occur, which collects some or all of the user information illustrated in Table 13. Also communicated to application server 200 as a result of the Parking Square QR code scan is one or more identifiers referred to in this example as ParkingSquareID information. This identifier or group of identifiers is used by application server 200 to uniquely identify the “specific” parking space or parking “proximity.” Once the user's identity credentials and the ParkingSquareID information have been provided to application server 200, the user is authenticated and, in one embodiment, application server 200 queries the user to determine whether they are attempting to create a new parking reminder or whether they would like to view previously set parking reminders (step 2). In step 3, the user responds to application server 200 with an indication that a new parking reminder is being set. Application server 200 generates a parking reminder binding record that includes information that identifies or can be used to identify the user as well as the ParkingSquareID information. Parking Square QR code scan timestamp information may also be stored in the parking reminder binding record. Exemplary parking reminder binding record data is illustrated in Table 16 and includes scan transaction identifier information 532, ParkingSquareID information 534, scanning UserID information 536, and parking reminder set timestamp information 538. A parking reminder “set” confirmation indication/message may be communicated to the user, as indicated in step 5. Also, in one embodiment, a digital reward may be granted to the user in response to receipt of the parking reminder “set” scan (step 6). Exemplary digital reward data is illustrated in Tables 17-18 (FIG. 14B) and includes scan transaction identifier information 532, granted reward identifier information 540, reward grant timestamp 542, reward identifier information 544, reward description information 542, and reward expiration information 544. Such digital participation rewards may be redeemed via a reward redemption transaction that is hosted by or in conjunction with application server 200. In one embodiment, server 200 may grant a digital reward, where the particular digital reward granted that is based, at least in part, on the location of the associated parking space. For example, server 200 may be provisioned such that a digital reward for Joe's Coffee Shop is distributed to users who scan a Parking Square associated with a parking space that is near or in the proximity of Joe's Coffee Shop. In another example, server 200 may be provisioned such that a digital reward for Joe's Coffee Shop is distributed to users who scan a Parking Square and set and/or retrieve a parking reminder associated with a parking space that is near or in the proximity of Joe's Coffee Shop.

In FIG. 12B a Parking Square QR code 406 is scanned by a user's mobile communication device 402 once the user has returned from his or her travels and would like to be reminded of where they previously parked. In step 1, the scanning user's login credentials are communicated to application server 200 in a manner similar to that previously described. Also communicated to application server 200 as a result of the Parking Square QR code 406 scan is ParkingSquareID information, in a manner similar to that previously described. Once the user's identity credentials and the ParkingSquareID information have been provided to application server 200, the user is authenticated and, in one embodiment, application server 200 queries the user to determine whether they are attempting to create a new parking reminder or whether the user would like to view previously set parking reminders (step 2). In step 3, the user responds to application server 200 with an indication that viewing of previously set parking reminders is desired. Application server 200 uses the provided user identifying information to access parking reminder binding records and locate the most recently set parking reminder associated with the user (step 4). The parking reminder information (e.g., parking location information, “specific” or “proximity”) is extracted from the parking reminder binding record and returned to the user's mobile device 402 for display to the user (step 5). In alternate embodiments, some or all previously set parking reminders associated with the user may be located and the associated parking location information extracted and returned to the user. In one embodiment, a participation reward may be granted to the user in response to receipt of the parking reminder “retrieve” scan (step 6). Such participation rewards may be redeemed via a reward redemption transaction that is hosted by or in conjunction with application server 200.

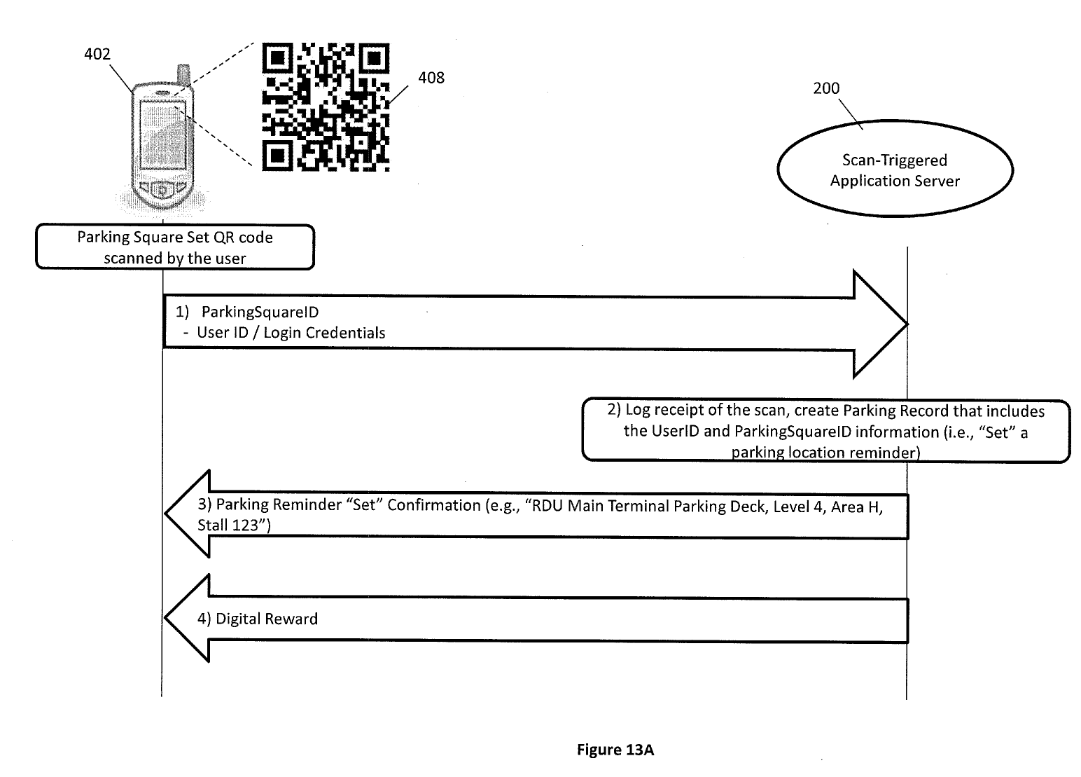

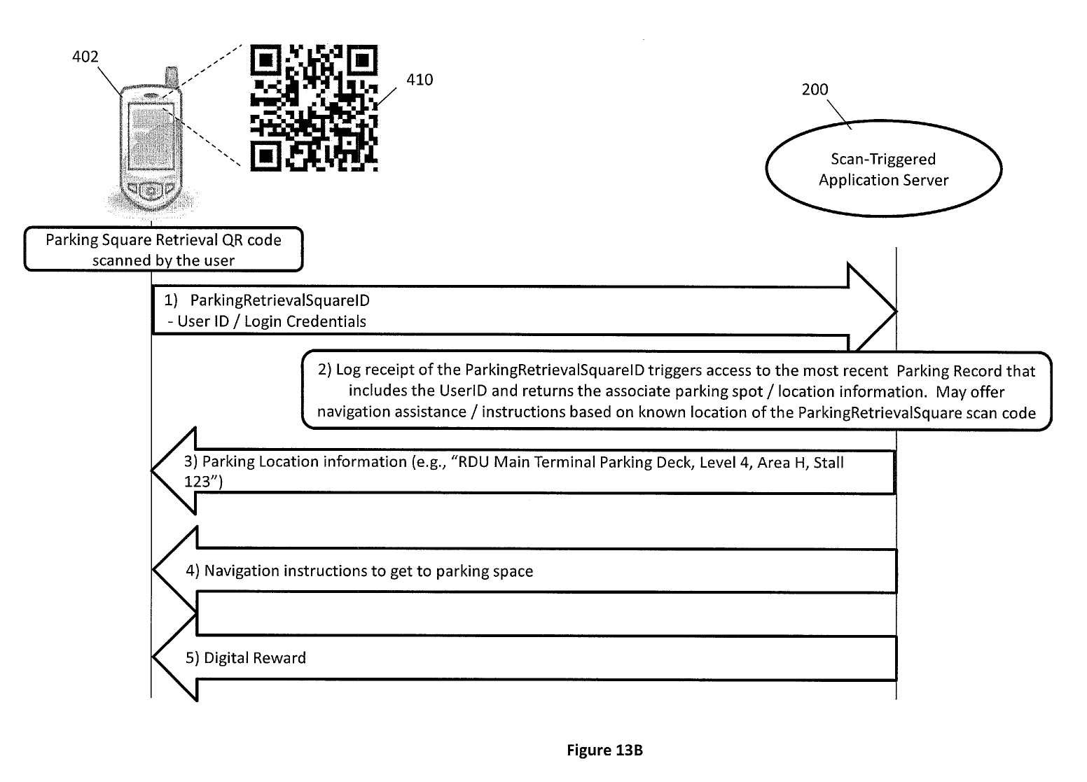

Presented in FIG. 13A is an alternate embodiment of the subject matter described herein that makes use of two distinct types of Parking Square QR codes. The first type of Parking Square QR code is referred to herein as a Parking Square “set” QR code 408, which is used to set a parking reminder. The second type of Parking Square QR code is referred to herein as a Parking Square “retrieval” QR code 410, which is used to retrieve and display a previously set parking reminder. With regard to the setting of a parking reminder, processing is very similar to that described above. The primary difference is that application server 200 does not need to query the user to determine whether they are intending to set a new parking reminder or retrieve/view an existing parking reminder. In this embodiment, user intent is implicitly understood by application server based on the particular type of Parking Square QR code that the user scans.

In FIG. 13A a Parking Square “set” QR code 408 is scanned by a user's mobile communication device 402 once the user has selected a space and parked. In step 1, the scanning user's login credentials are communicated to application server 200, in a manner similar to that previously described. Also communicated to application server 200 as a result of the Parking Square “set” QR code scan is one or more identifiers referred to in this example as ParkingSquareID information. This identifier or group of identifiers is used by application server 200 to uniquely identify the “specific” parking space or parking “proximity.” Once the user's identity credentials and the ParkingSquareID information have been provided to application server 200, application server 200 generates a parking reminder binding record that includes information that identifies or can be used to identify the user as well as the ParkingSquareID information (step 2). Parking Square QR code scan timestamp information may also be stored in the parking reminder binding record. A parking reminder “set” confirmation indication/message may be communicated to the user, as indicated in step 3. Also, in one embodiment, a participation reward may be granted to the user in response to receipt of the parking reminder “set” scan (step 4).

In FIG. 13B a Parking Square “retrieval” QR code 410 is scanned by a user's mobile communication device 402 once the user has returned from his or her travels and would like to be reminded of where the user previously parked. In step 1, the user's login credentials are communicated to application server 200, in a manner similar to that previously described. Also communicated to application server 200 as a result of the Parking Square “retrieval” QR code 410 scan is ParkingRetrievalSquareID information, which is information extracted from the QR code 410 which is interpreted by application server 200 as an implicit indication that the user is requesting to view previously set parking reminder information. In another embodiment of the present subject matter disclosed herein, a user may simply scan any Parking Square scan code that contains any ParkingSquareID identifier in order to retrieve a previously set parking reminder. In such cases, a ParkingSquareID identifier may server the same purpose as a ParkingRetrievalSquareID identifier. In either case, scanning of a Parking Square scan code that includes a code that may be used or interpreted as a ParkingRetrievalSquareID identifier enables the scanning user to retrieve and view a previously set parking reminder.

In any event, once the user's identity credentials and the ParkingRetrievalSquareID information have been provided to application server 200, the user is authenticated and application server 200 uses the provided user identifying information to access parking reminder binding records and locate the most recently set parking reminder associated with the user (step 2). The parking reminder information (e.g., parking location information, “specific” or “proximity”) is extracted from the parking reminder binding record and returned to the user's mobile device 402 for display to the user (step 3). In alternate embodiments, some or all previously set parking reminders associated with the user may be located and the associated parking location information extracted and returned to the user. In one embodiment, ParkingRetrievalSquareID information may encode location information similar to that of a Parking Square “set” QR code. An example of information that may be encoded in a parking retrieval square ID is illustrated in Table 19 in FIG. 14B. In the illustrated example, information that may be associated with a ParkingRetrievalSquareID 546 includes a parking facility ID or description 548, a parking lot ID 550, and a parking level ID 552. As such, application server 200 may be able to identify, track and log/record where a user is standing when they scan Parking Square “retrieval” QR code 410. This information may be useful in enabling application server 200 to help the user navigate to the user's parking space from the point of the Parking Square “retrieval” QR code 410 scan (step 4). In one embodiment, a participation reward may be granted to the user in response to receipt of the parking reminder “retrieve” scan (step 5).

It will be appreciated that in the examples presented herein, it is assumed that the user has previously registered to use the scan code-based services platform, and as such the user registration information shown in Table 13 has already been provided by the user. In the event that the user is not already a registered user of the scan code-based services platform, then such registration information may be collected from the user upon the user's first scan of a Parking Square QR code. Alternative, Parking Square service may be provided in an anonymous mode, whereby a mobile device tracking identifier is generated (e.g., randomly) and temporarily stored on the scanning user's mobile device, such that subsequent scans by the same mobile device can be correlated/associated/identified. The necessary mobile device “bindings” may be made and stored by server 200 in a manner similar to that described above with respect to registered service users. However, in this anonymous mode of operation, no explicit user registration is required (i.e., the scanning user does not have to agree to create an account and provide contact or user identifying information). As such, Parking Square services may be provided in an “anonymous” manner.

It will be appreciated with regard to the Parking Square service embodiments described above that such services may also be provided via a native Parking Square application that is installed on the user's smartphone. In such cases, information that identifies or can be used to identify the address of a Parking Square server to which the appointment information should be communicated need not be encoded within the Parking Square QR code that is displayed to and scanned by an owner. In such native application deployments, the information that identifies or can be used to identify the address of a Parking Square server may be pre-configured and stored in the smartphone's memory, such as in data storage module 116. Alternatively, the native application may dynamically determine the address of the appropriate Parking Square server at the time of the Parking Square QR code scan by the user. In such scenarios, Parking Square processing is very similar to that described above, except that the address of the Parking Square server is not obtained by a user scan of a Parking Square QR code.

It will be appreciated that in some embodiments of the Parking Square service, a user may access the service by using any generic QR code scanner application or built-in QR scanning functionality on the user's mobile device (e.g., smartphone, computer integrated eyewear, wearable computer, tablet computer, etc.). In such cases, Parking Square scan codes may include encoded information that can be used by the QR scanner application or function to identify or locate the scan-triggered server that is hosting/providing Parking Square service. For example, the Parking Square scan code may include an encoded URL associated with the hosting Parking Square scan-triggered server or scan-triggered service provider. Exemplary information that identifies or can be used to identify a network server or host computer for providing Parking Square service may include, but is not limited to, a uniform resource locator (URL) and URL parameters, an Internet protocol (IP) address and port identifier. In other embodiments, a native application may be deployed on the scanning user/owner's mobile device which can perform some of the functions described/attributed to the scan-triggered server in the embodiments described above. As such, at least some of the functions and information associated with the setting and retrieving of a parking reminder and associated processing may be performed locally on the user's mobile device without departing from the scope of the subject matter described herein.

A system for setting and retrieving a parking reminder via the scanning of a scanable code by the user of a scan-enabled client module may include a computer platform including a processor. The system may further include a server application module executable by the processor and configured to receive, from a scan-enabled client module associated with a user, parking location identifying information obtained from the scanning of a first scanable code. The server application module may be further configured to receive information that can be used to identify the user. The server application module may be further configured to create and store a binding record that associates the user and the parking location identifying information.

The server application module may be further configured to receive, from a scan-enabled client module associated with a user, parking reminder retrieval information obtained from the scanning of a second scanable code. The server application module may be further configured to receive information that can be used to identify the user. The server application module may be further configured to use the parking reminder retrieval and user identifying information to access the binding record and retrieve the parking location identifying information. The server application module may be further configured to communicate the parking location identifying information to the user.

A method for setting and retrieving a parking reminder via the scanning of a scanable code by the user of a scan-enabled client module includes receiving, from a scan-enabled client module associated with a user, parking location identifying information obtained from the scanning of a first scanable code. The method further includes receiving information that can be used to identify the user. The method further includes creating and storing a binding record that associates the user and the parking location identifying information.

The method further includes receiving, from a scan-enabled client module associated with a user, parking reminder retrieval information obtained from the scanning of a second scanable code. The method further includes receiving information that can be used to identify the user. The method further includes using the parking reminder retrieval and user identifying information to access the binding record and retrieve the parking location identifying information. The method further includes communicating the parking location identifying information to the user.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth herein.

What is claimed is:

1. A system for facilitating the recovery of a lost item using information obtained from the scanning of a scanable code by the user of a scan-enabled client module, the system comprising:
a computing platform including a processor;
a server application module executable by the processor and configured to:
receive, from a scan-enabled client module, information obtained from the scanning of a scanable code which can be used to identify the owner of the scanable code;
use the received owner identifying information to determine a contact address information for the owner; and
use the contact address information to communicate a pick-up notification message to the owner.

2. The system of claim 1 where the scan-enabled client module resides on a mobile communication device.

3. The system of claim 1 where the server application module resides on a network application server.

4. The system of claim 1 where the information obtained from the scanning of a scanable code includes SherpaSquareID identifier information.

5. The system of claim 1 where the server application module is configured to determine a drop-off location by using the information to access a binding record that contains provisioned drop-off location information.

6. The system of claim 1 where the server application module is configured to determine the registered owner of the scanable code by using the information to access a binding record that contain provisioned owner registration information.

7. The system of claim 1 where the server application module is configured to generate a pick-up notification message and communicating the notification message to the registered owner.

8. The system of claim 1 where the information obtained from the scanning of a scanable code is obtained from the scanning of a scanable code by a receiving agent.

9. A method for facilitating the recovery of a lost item using information obtained from the scanning of a scanable code by the user of a scan-enabled client module, the method comprising:
receiving, from a scan-enabled client module associated with a user, information obtained from the scanning of a scanable code which can be used to identify the owner of the scanable code;
accessing provisioned contact address information for the owner; and
using the contact address information to communicate a pick-up notification message to the owner that includes pick-up location information.

10. The method of claim 9 where receiving information from a scan-enabled client module associated with a user includes receiving information obtained via a scanner module associated with a mobile communication device.

11. The method of claim 9 where receiving information includes receiving SherpaSquareID information obtained from the scanning of a scanable code element.

12. The method of claim 9 including using the information to determine the registered owner of the scanable code by accessing a binding record that contain provisioned owner registration information.

13. The method of claim 9 where the information obtained from the scanning of a scanable code is obtained from the scanning of a scanable code by a receiving agent.

14. The method of claim 13 where the pick-up location information is based, at least in part, the receiving agent.

15. A system for facilitating the recovery of a lost item using information obtained from the scanning of a scanable code by the user of a scan-enabled client module, the system comprising:
a computing platform including a processor;
a server application module executable by the processor and configured to:
receive, from a scan-enabled client module associated with a user, information obtained from the scanning of a scanable code which triggers the creation of an event flight plan for the user;
collect and store flight plan event detail information;
associate a guardian with the flight plan event; and
associate an event notification trigger with the event.

16. The system of claim 15 where the scan-enabled client module resides on a mobile communication device.

17. The system of claim 15 where the server application module resides on a network application server.

18. The system of claim 15 where information obtained from the scanning of a scanable code includes SherpaSquareID information.

19. The system of claim 15 where the server application module is configured to use the information to determine the registered owner of the scanable code by accessing a binding record that contain provisioned owner registration information.

20. The system of claim 15 where the server application module is configured to notify the guardian if the user does not close out the event prior to firing of the event notification trigger.

21. The system of claim 15 where the server application module is configured to receive information obtained from the scanning of a scanable code which triggers the closing out of the event flight plan.

22. The system of claim 15 where the server application module is configured to communicate an event close out invitation message to the user, where the message includes a hyperlink that when activated is adapted to trigger the closing out of the event flight plan.

23. The system of claim 15 where the server application module is adapted to issue a digital reward to the user.

24. A method for providing event tracking and notification service via the scanning of a scanable code by the user of a scan-enabled client module, the method comprising:
receiving, from a scan-enabled client module associated with a user, information obtained from the scanning of a scanable code which triggers the creation of an event flight plan for the user;
collecting and storing flight plan event detail information;
associating a guardian with the flight plan event; and
associating an event notification trigger with the event.

25. The method of claim 24 where the scan-enabled client module resides on a mobile communication device.

26. The method of claim 24 where the server application module resides on a network application server.

27. The method of claim 24 where the information obtained from the scanning of a scanable code includes SherpaSquareID information.

28. The method of claim 24 including notifying the guardian if the user does not close out the event prior to firing of the event notification trigger.

29. The method of claim 24 including receiving information obtained from the scanning of a scanable code which triggers the closing out of the event flight plan.

30. The method of claim 24 including communicating an event close out invitation message to the user, where the message includes a hyperlink that when activated is adapted to trigger the closing out of the event flight plan.

31. The method of claim 24 including issuing a digital reward to the user.
